(19) United States
(12) Patent Application Publication
(10) Pub. No.: US 2023/0228681 A1
(43) Pub. Date: Jul. 20, 2023

(54) Method Of And Optical System For Illuminating A Sample Surface

(71) Applicant: Advanced Instrument PTE. LTD., Singapore (SG)

(72) Inventors: Ronian Han Weng Siew, Vancouver (CA); Soo Fan Phua, Singapore (SG); Sheau Yeng Wei, Singapore (SG)

(73) Assignee: Advanced Instrument PTE. LTD., Singapore (SG)

(21) Appl. No.: 18/001,468

(22) PCT Filed: Jun. 11, 2020
(86) PCT No.: PCT/SG2020/050327

§ 371 Date: Dec. 10, 2022

(51) Int. Cl. G01N 21/64

(52) U.S. Cl. CPC G01N 21/6456; G01N 2021/6467; G01N 2021/6478; G01N 2021/6471

(57) ABSTRACT

Various embodiments may provide a method of illuminating a sample surface. The method may include arranging an illumination subsystem, the illumination subsystem including an optical source and at least one lens, having an optic axis at an incident angle greater than 0° and less than 90° to a normal of the sample surface such that a reference illumination distribution is directly generated on the sample surface based on optical light emitted by the illumination subsystem. The method may also include arranging an adjustment optical subsystem such that an adjusted illumination distribution which is more symmetrical compared to the reference illumination distribution is generated on the sample surface based on optical light emitted by the illumination subsystem.

### TECHNICAL FIELD

Various aspects of this disclosure relate to a method of illuminating a sample surface. Various aspects of this disclosure may relate to an optical system for illuminating a sample surface.

### BACKGROUND

Certain applications require a surface to be illuminated in order to perform analysis on objects or biological samples (“bio-samples”) located on the surface. For example, in industrial inspection systems, electronic components (such as resistors, capacitors, and wire bonds) on a printed circuit board (PCB) may require illumination, and a camera may be used to capture the reflected or scattered light from the components for further analysis. For applications in the life sciences, bio-samples located on a surface may need to be illuminated for biological analysis. Examples include (but are not necessarily limited to) optical microscopy, bioluminescent detection, forensics, fluorescence spectroscopy, and fluorescence detection in quantitative polymerase chain reaction (PCR).

In any of the above applications, it may be desirable to have a uniform distribution of the illumination across the sample plane. In other words, it may be desirable for the irradiance (i.e., the optical power per unit area, in units such as Watts per square centimeter) across the sample plane to be spatially constant such that there is little or no variation in brightness of the illumination across the sample plane.

### SUMMARY

Various embodiments may provide a method of illuminating a sample surface. The method may include arranging an illumination subsystem, the illumination subsystem including an optical source and at least one lens, having an optic axis at an incident angle greater than 0° and less than 90° to a normal of the sample surface such that a reference illumination distribution is directly generated on the sample surface based on optical light emitted by the illumination subsystem. The method may also include arranging an adjustment optical subsystem such that an adjusted illumination distribution which is more symmetrical compared to the reference illumination distribution is generated on the sample surface based on optical light emitted by the illumination subsystem.

Various embodiments may provide an optical system for illuminating a sample surface. The optical system may include an illumination subsystem including an optical source and at least one lens. The optical system may also include an adjustment optical subsystem. The adjustment optical subsystem may be configured to be arranged such that an adjusted illumination distribution generated on the sample surface based on optical light emitted by the illumination subsystem is more symmetrical compared to a reference illumination distribution generated directly on the sample surface based on optical light emitted by the illumination subsystem when the illumination subsystem is arranged such that an optic axis of the illumination subsystem is at an incident angle greater than 0° and less than 90° to a normal of the sample surface.

### BRIEF DESCRIPTION OF THE DRAWINGS

The invention will be better understood with reference to the detailed description when considered in conjunction with the non-limiting examples and the accompanying drawings, in which:

FIG. 1 is a schematic showing a method of illuminating a sample plane.

FIG. 2 is a general illustration of a method of illuminating a sample surface according to various embodiments.

FIG. 3 is a general illustration of an optical system for illuminating a sample surface according to various embodiments.

FIG. 4 is a schematic showing a method of achieving greater illumination symmetry on a sample surface according to various embodiments.

FIG. 5 is a schematic showing a method of achieving greater illumination symmetry on a sample surface according to various other embodiments.

FIG. 6 is a schematic showing a method of achieving greater illumination symmetry on a sample surface according to yet various other embodiments.

FIG. 7 is a schematic showing a method of achieving greater illumination symmetry on a sample surface according to yet various other embodiments.

FIG. 8 is a schematic showing a method of achieving greater illumination symmetry on a sample surface according to yet various other embodiments.

FIG. 9 is a schematic illustrating the shifting of an optical source across a mounting plane in the illumination subsystem to increase the region of symmetry of the illumination distribution on the sample surface according to various embodiments.

FIG. 10A is a schematic showing illumination subsystem 1 may be activated (i.e. turned “on”) while the illumination subsystems 2 and 3 may be deactivated (i.e. turned “off”) according to various embodiments.

FIG. 10B is a schematic showing illumination subsystem 2 may be activated (i.e. turned “on”) while the illumination subsystems 1 and 3 may be deactivated (i.e. turned “off”) according to various embodiments.

FIG. 10C is a schematic showing illumination subsystem 3 may be activated (i.e. turned “on”) while the illumination subsystems 1 and 2 may be deactivated (i.e. turned “off”) according to various embodiments.

FIG. 11A is a schematic showing illumination subsystem 1 may be activated (i.e. turned “on”) while the illumination subsystems 2 and 3 may be deactivated (i.e. turned “off”) according to various embodiments.

FIG. 11B is a schematic showing illumination subsystem 2 may be activated (i.e. turned “on”) while the illumination subsystems 1 and 3 may be deactivated (i.e. turned “off”) according to various embodiments.

FIG. 11C is a schematic showing illumination subsystem 3 may be activated (i.e. turned “on”) while the illumination subsystems 1 and 2 may be deactivated (i.e. turned “off”) according to various embodiments.

FIG. 12A is a table showing a lens prescription for an illumination subsystem according to various embodiments.

FIG. 12B is a schematic illustrating the horizontal layout of an illumination subsystem having the lens prescription as shown in FIG. 12A according to various embodiments.

FIG. 13A is a schematic showing the illumination subsystem as illustrated in FIG. 12B according to various embodiments being mounted such that the illumination subsystem axis (optic axis) is at an oblique angle (θ) of 35° from the dotted line, which indicates the normal to the sample surface.

FIG. 13B is a plot of irradiance (in watts per square centimeters or Watts/cm²) as a function of distance along the y-axis (in millimeters or mm) showing the resulting irradiance profile generated by the system shown in FIG. 13A along the y-axis of the sample surface.

FIG. 13C is a grey scale surface plot showing the illumination distribution generated by the system shown in FIG. 13A at the sample surface along the x-axis and the y-axis.

FIG. 14A is a schematic showing the illumination subsystem as illustrated in FIG. 12B according to various embodiments used in conjunction with a prism according to various embodiments.

FIG. 14B is a plot of irradiance (in watts per square centimeters or Watts/cm²) as a function of distance along the y-axis (in millimeters or mm) showing the resulting irradiance profile generated by the system shown in FIG. 14A along the y-axis of the sample surface.

FIG. 14C is a grey scale surface plot showing the illumination distribution generated by the system shown in FIG. 14A at the sample surface along the x-axis and the y-axis.

FIG. 15A is a schematic showing the illumination subsystem as illustrated in FIG. 12B according to various embodiments used in conjunction with a deflection lens according to various embodiments.

FIG. 15B is a plot of irradiance (in watts per square centimeters or Watts/cm²) as a function of distance along the y-axis (in millimeters or mm) showing the resulting irradiance profile generated by the system shown in FIG. 15A along the y-axis of the sample surface.

FIG. 15C is a grey scale surface plot showing the illumination distribution generated by the system shown in FIG. 15A at the sample surface along the x-axis and the y-axis.

FIG. 16A is a schematic showing the illumination subsystem as illustrated in FIG. 12B according to various embodiments used in conjunction with a mirror according to various embodiments.

FIG. 16B is a plot of irradiance (in watts per square centimeters or Watts/cm²) as a function of distance along the y-axis (in millimeters or mm) showing the resulting irradiance profile generated by the system shown in FIG. 16A along the y-axis of the sample surface.

FIG. 16C is a grey scale surface plot showing the illumination distribution generated by the system shown in FIG. 16A at the sample surface along the x-axis and the y-axis.

FIG. 17A is a schematic showing the illumination subsystem as illustrated in FIG. 12B according to various embodiments used in conjunction with a prism according to various embodiments.

FIG. 17B is a plot of irradiance (in watts per square centimeters or Watts/cm²) as a function of distance along the y-axis (in millimeters or mm) showing the resulting irradiance profile generated by the system shown in FIG. 17A along the y-axis of the sample surface.

FIG. 17C is a grey scale surface plot showing the illumination distribution generated by the system shown in FIG. 17A at the sample surface along the x-axis and the y-axis.

FIG. 18A is a schematic showing the illumination subsystem as illustrated in FIG. 12B according to various embodiments used in conjunction with the prism and with the optical source, i.e. the light emitting diode (LED), shifted by 0.2 mm in the direction shown by the arrow according to various embodiments.

FIG. 18B is a plot of irradiance (in watts per square centimeters or Watts/cm²) as a function of distance along the y-axis (in millimeters or mm) showing the resulting irradiance profile generated by the system shown in FIG. 18A along the y-axis of the sample surface.

FIG. 18C is a grey scale surface plot showing the illumination distribution generated by the system shown in FIG. 18A at the sample surface along the x-axis and the y-axis.

FIG. 19A is a schematic showing two illumination subsystems as illustrated in FIG. 12B according to various embodiments mounted next to each other according to various embodiments.

FIG. 19B is a plot of irradiance (in watts per square centimeters or Watts/cm²) as a function of distance along the x-axis (in millimeters or mm) showing the resulting irradiance profile generated by the system shown in FIG. 19A along the x-axis of the sample surface.

FIG. 19C is a grey scale surface plot showing the illumination distribution generated by the system shown in FIG. 19A at the sample surface along the x-axis and the y-axis.

FIG. 20A is a schematic showing two illumination subsystems mounted next to each other as shown in FIG. 19A but with the mirrors tilted by 1 degree about the y-axis in the directions as shown according to various embodiments.

FIG. 20B is a plot of irradiance (in watts per square centimeters or Watts/cm²) as a function of distance along the x-axis (in millimeters or mm) showing the resulting irradiance profile generated by the system shown in FIG. 20A along the x-axis of the sample surface.

FIG. 20C is a grey scale surface plot showing the illumination distribution generated by the system shown in FIG. 20A at the sample surface along the x-axis and the y-axis.

FIG. 21A is a schematic showing an optical system according to various embodiments.

FIG. 21B is a schematic showing an optical system according to various other embodiments.

FIG. 21C is a schematic showing an optical system according to yet various other embodiments. In various embodiments, the pairs of illumination subsystems may illuminate a circular sample surface.

FIG. 22A is a schematic showing an optical system including two pairs of illumination subsystems according to various embodiments.

FIG. 22B is a schematic showing a side view of the optical system shown in FIG. 22A with filters according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Embodiments described in the context of one of the methods or optical systems are analogously valid for the other methods or optical systems. Similarly, embodiments described in the context of a method are analogously valid for an optical system, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

If the illumination is substantially uniform across a sample plane, then all flat objects across the sample plane may receive the same amount of optical flux. Additionally, if the objects across the sample plane are not flat but also not too tall (such as small electronic components on a PCB), then all non-flat objects across the sample plane may also receive approximately equal illumination. Since a small object possesses a small but finite volume, then the entire volume of an object at the sample plane receives illumination. In this case, a collection of many such small objects located across a sample plane may also receive approximately equal illumination if there is uniform illumination across the sample plane. Since volume is equal to the product of area with height (i.e., Volume=Area×Height), having uniform illumination across a sample plane may result in approximately uniform illumination throughout a planar volume (such as the volume of fluid trapped under a microscope cover glass slide, or the volume of fluid lying on top of a flat surface). Accordingly, if bio-samples are located inside a planar volume (such as a volume of fluid under a microscope cover glass slide), then having uniform illumination across a plane above or below the planar volume may also result in an approximately uniform distribution of illumination throughout the volume in which the bio-samples reside. Therefore, where there is uniform illumination at a sample plane, there may be approximately uniform distribution of illumination throughout a planar volume above or under the sample plane.

Even if there is some variation in the illumination distribution onto a sample plane, as long as the variation is minimal and is symmetric about the center of the sample plane, then the variation may be considered acceptable. For example, commercial photographic lenses in cameras often produce an illumination across the image plane that is brightest at the center, and gradually darkens at the corners. When the illumination distribution is symmetric about the center of the sample plane such that the center has the brightest illumination, it may be said that the illumination distribution has rotationally symmetric relative illumination (or rotationally symmetric relative illuminance).

Having a substantially uniform illumination or a rotationally symmetric relative illumination may be desirable for the following reasons.

Firstly, a substantially uniform illumination or a rotationally symmetric relative illumination may be aesthetically pleasing to view.

Secondly, industrial inspection systems may require distinguishing between brighter and darker objects located at various subareas across the sample plane. If the illumination is non-uniform, then dark objects that are located at brightly illuminated subareas may appear brighter than they actually are, and bright objects that are located at dimly illuminated subareas may appear darker than they actually are. If there is rotationally symmetric relative illumination across the sample plane, and if the variation of the relative illumination is minimal, then it may still be possible to distinguish between brighter and darker objects across subareas at the sample plane. If the relative illumination distribution across the sample plane is not rotationally symmetric, then it is often the case that there is excessive optical flux located at a subarea on the sample plane, and insufficient optical flux located at a different subarea on the sample plane. Usually, a rotationally symmetric relative illumination redistributes optical flux more evenly such that all subareas across the sample plane possess sufficient optical flux. Additionally, a rotationally symmetric relative illumination may result in improved illumination uniformity.

Thirdly, in biological applications, fluorescent bio-samples (such as dye molecules or “probes” that are used for labelling cells and DNA molecules) located across a sample plane may be expected to be emitting equal fluorescence signals when illuminated. If the illumination distribution is non-uniform across the sample plane, then the fluorescent signals would not be emitting uniformly, which may be problematic. For example, in quantitative PCR applications (such as digital PCR), when arrays of reaction chambers are emitting equal fluorescence signals upon being illuminated, it is often understood that the concentrations of DNA molecules inside all of the reaction chambers are equal. But if the illumination were non-uniform, then there may be observable differences in fluorescence emission among reaction chambers, which may result in an erroneous conclusion that there are different concentrations of DNA molecules among the reaction chambers. However, if there is rotationally symmetric relative illumination across the sample plane, and if the variation of the relative illumination is minimal, then it may be possible to have sufficiently uniform fluorescent signals being emitted by bio-samples across the sample plane. In this case, it may be possible to not make erroneous conclusions about the concentrations of DNA molecules among the reaction chambers. If the relative illumination distribution across the sample plane is not rotationally symmetric, then it is often the case that there is excessive optical flux located at a subarea on the sample plane, and insufficient optical flux located at a different subarea on the sample plane. Usually, a rotationally symmetric relative illumination redistributes optical flux more evenly such that all subareas across the sample plane possess sufficient optical flux. In this case, the bio-samples inside all reaction chambers across the sample plane may receive sufficient optical flux. Additionally, a rotationally symmetric relative illumination may result in improved illumination uniformity.

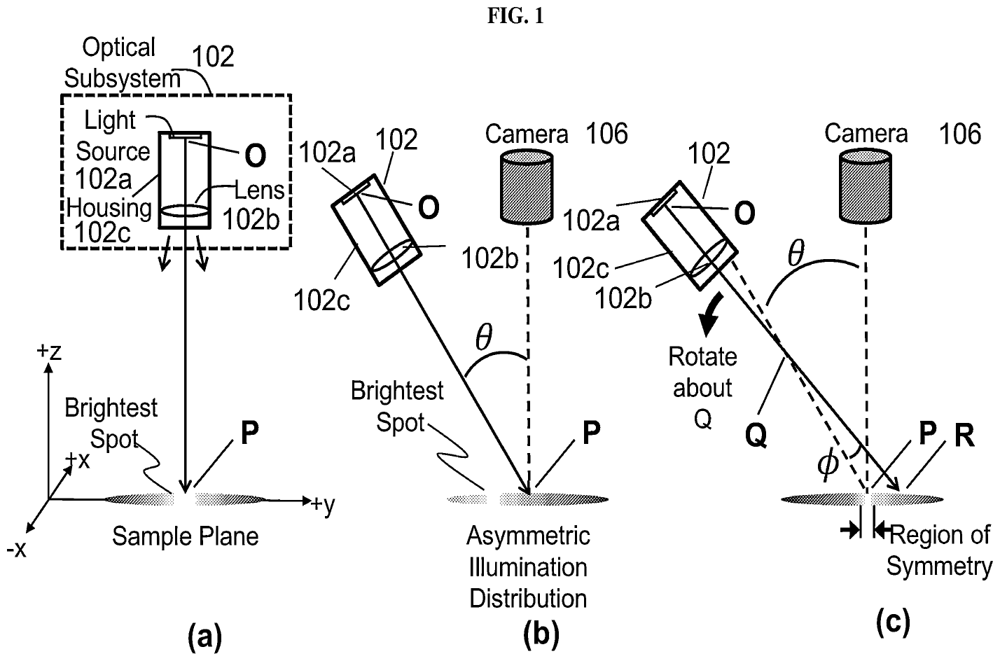

FIG. 1 is a schematic showing a method of illuminating a sample plane. The optical system may include an illumination subsystem 102 including an optical or light source 102a (alternatively referred to as simply a “source”), at least one lens 102b in front of the optical source 102a, and a housing 102c, which may by a hollow barrel or cylinder that allow mounting of the light source 102a and the at least one lens 102b within the hollow space of the barrel or cylinder. In FIG. 1(a), the illumination subsystem 102 may be situated directly above the sample plane, in the +y dimension. The line joining point O with point P represents the central ray travelling from point O at the source 102a towards point P at the sample plane, which is the center of the sample plane. Thus, the line OP is normal to the sample plane and centered at the sample plane. Under this condition, there may be a brightest spot of light at the center of the sample plane. In order to perform analysis on objects (such as bio-samples) receiving the illumination, a camera 106 may be mounted above the sample plane. As shown in FIG. 1(b), the illumination subsystem 102 may be required to be mounted at an oblique angle θ about the pivot point P. Consequently, there may result an asymmetric distribution of illumination at the sample plane. The reason is because light rays arriving at the sample plane from the illumination subsystem 102 may travel different distances. Rays from the illumination subsystem 102 that arrive at positions to the left of point P may travel at smaller distances between the illumination subsystem 102 and the sample plane than rays from the illumination subsystem 102 that arrive at positions to the right of point P. Due in part to the inverse square law of light propagation, those rays arriving at positions to the left of point P may result in higher flux density at the sample plane, and rays arriving at positions to the right of point P may result in lower flux density. However, due to the rotationally symmetric relative illumination at the sample plane caused by the illumination subsystem 102 under the condition shown in FIG. 1(a), when the illumination subsystem 102 is made to be tilted such that it is under the condition illustrated in FIG. 1(b), there may result lower irradiance for rays arriving at positions towards the left of the brightest spot at the sample plane. As depicted in FIG. 1(b), this may result in a gradual reduction of irradiance towards the far-left edge of the sample plane. Consequently, there may be an asymmetric illumination distribution at the sample plane, which is depicted in FIG. 1(b). It should be appreciated that as long as there is a maximum of a single illumination subsystem 102 including at least one rotationally symmetric lens 102b that is centered with respect to the source, and as long as the ray joining points O and P rotates about the point P as shown in FIG. 1(b), there may be no magnitude of the angle θ that will enable placement of the brightest spot to be located at P, except θ=0. A prior work relates, as shown in FIG. 1(c), to a method to adjust the illumination distribution such that there is greater symmetry of the illumination distribution about P by rotating the illumination subsystem 102 about a pivot point between O and P. In this figure, the illumination subsystem 102 is depicted to be rotated (in the direction given by the thick black curved arrow) by an angular magnitude ϕ about pivot point Q, which is somewhere between O and P, such that the brightest spot is placed at P, and the ray originating from O is directed towards point R. This may result in a central spot of illumination within the adjusted illumination distribution, i.e. a region of symmetry, about point P, as depicted by the two arrows at the bottom of FIG. 1(c).

However, the rotation of the illumination subsystem 102 about the pivot point Q by a tilt angle ϕ for achieving illumination symmetry may require a mechanical structure. Further, such a rotation may require motion of the entire illumination subsystem 102. The illumination subsystem 102 may additionally include a filter and other optical components (not shown in FIG. 1), and may therefore be quite heavy. The motion of the illumination subsystem 102 may introduce mechanical stresses and strains on the mechanical structure that hold the illumination subsystem 102.

Various embodiments may seek to provide a method that enable greater illumination symmetry at the central region (i.e. at position P) of the sample plane or sample surface without tilting the illumination subsystem 102. Various embodiments may provide a means to deflect or redirect ray OP such that there is greater symmetry of illumination within a region near P at the sample plane.

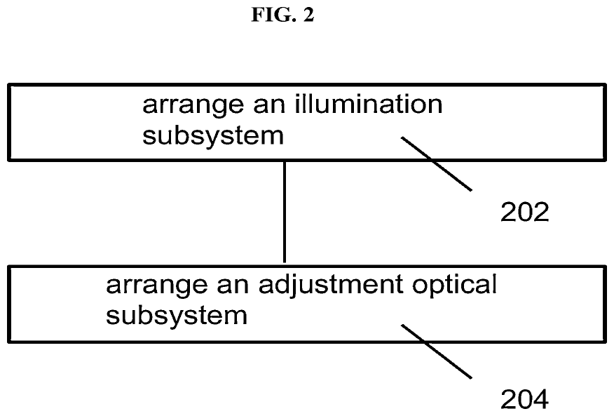

FIG. 2 is a general illustration of a method of illuminating a sample surface according to various embodiments. The method may include, in 202, arranging an illumination subsystem, the illumination subsystem including an optical source and at least one lens, having an optic axis at an incident angle greater than 0° and less than 90° to a normal of the sample surface such that a reference illumination distribution is directly generated on the sample surface based on optical light emitted by the illumination subsystem. The method may also include, in 204, arranging an adjustment optical subsystem such that an adjusted illumination distribution which is more symmetrical compared to the reference illumination distribution is generated on the sample surface based on optical light emitted by the illumination subsystem.

In other words, the method may first involve forming an asymmetric illumination distribution by positioning or orientating the optic axis of the illumination system at an acute, non-zero angle from the normal of the sample surface, and then arranging or providing an adjustment optical subsystem such that the illumination distribution on the sample surface becomes more symmetrical.

In various embodiments, a symmetrical illumination distribution may be a rotationally symmetric relative illumination distribution. In various other embodiments, a symmetrical illumination distribution may be an illumination distribution symmetrical about a line, e.g. along an axis. The phrase “more symmetrical” may mean more rotationally symmetrical, or more symmetrical along the line.

In various embodiments, the sample surface may be a flat, planar surface. In various embodiments, the sample surface may not be flat. The sample surface may be formed by a plurality of low aspect ratio objects or structures, e.g. glass slides spaced apart from one another on a substrate.

The sample surface may be a surface of a sample, which may contain one or more volumes of fluid below or above the sample surface. The fluid may contain chemical or biological substances. For instance, the sample may include a substrate and several droplets of fluid on the surface of the substrate. In another example, the sample may include several glass slides, a substrate, and fluid droplets trapped between the glass slides and the substrate. Each droplet may form a planar volume. If there is substantially uniform illumination on the sample surface, there may also be substantially uniform illumination throughout the entire volumes of the droplets as the droplets have low aspect ratios.

In various embodiments, the reference illumination distribution directly being generated on the sample surface may mean that optical light from the illumination subsystem may be provided onto the sample surface to generate the reference illumination distribution without passing through optical elements such as prisms, deflection lenses or mirrors.

In various embodiments, the adjustment optical subsystem may include a prism arranged between the illumination subsystem and the sample surface such that optical light from the illumination subsystem is deflected or redirected by the prism (e.g, via refraction) to generate the adjusted illumination. The prism may be a tapered optical element having a substantially flat first main surface, and a substantially flat second main surface opposite and non-parallel to the first main surface. A minor surface joining the first main surface and the second main surface at one end may be longer than another minor surface joining the first main surface and the second main surface at another end. Accordingly, the prism may have different thicknesses along the first main surface and the second main surface. The angle between the first main surface and the second main surface may be referred to as a wedge angle or apex angle.

In various embodiments, the adjustment optical subsystem may include a deflection lens arranged between the illumination subsystem and the sample surface such that optical light from the illumination subsystem is deflected or redirected by the deflection lens (e.g, via refraction) to generate the adjusted illumination. The deflection lens may be a positive powered lens, such as a plano-convex lens, a bi-convex lens, or a cylindrical convex lens.

In various embodiments, the method may include moving the illumination subsystem such that optical light from the illumination subsystem travels away from the sample surface. The method may also include providing the adjustment optical subsystem including a mirror such that optical light generated by the illumination subsystem and traveling away from the sample surface is reflected by the mirror to generate a further reference illumination distribution on the sample surface. Arranging the adjustment optical subsystem may include tilting the mirror such that the adjusted illumination distribution is more symmetrical compared to the reference illumination distribution and more symmetrical compared to the further reference illumination distribution. A mirror may be an optical element having a reflecting or reflective surface that reflects incoming optical light.

In various embodiments, the method may include moving the illumination subsystem such that the optic axis (of the illumination subsystem) is parallel to the sample surface. The method may include providing the adjustment optical subsystem including a mirror such that optical light generated by the illumination subsystem and traveling along the optic axis is reflected by the mirror to generate a further reference illumination distribution on the sample surface. Arranging the adjustment optical subsystem may include tilting the mirror such that the adjusted illumination distribution is more symmetrical compared to the reference illumination distribution and more symmetrical compared to the further reference illumination distribution.

In various embodiments, the method may include moving the illumination subsystem such that the optic axis is parallel to the sample surface. The method may include providing the adjustment optical subsystem including a first mirror and a second mirror such that optical light generated by the illumination subsystem and traveling along the optic axis is reflected by the first mirror onto the second mirror and further reflected by the second mirror to generate a further reference illumination distribution on the sample surface. Arranging the adjustment optical subsystem may include tilting the second mirror such that the adjusted illumination distribution is more symmetrical compared to the reference illumination distribution and more symmetrical compared to the further reference illumination distribution.

In various embodiments, the method may include moving the optical source such that an area of a central spot of illumination or a region of symmetry within the adjusted illumination distribution is increased.

In various embodiments, the method may further include arranging a further illumination subsystem, the further illumination subsystem including a further optical source and at least one further lens, having a further optic axis at a further incident angle greater than 0° and less than 90° to a normal of the sample surface such that a further reference illumination distribution is directly generated on the sample surface based on optical light emitted by the further illumination subsystem. The method may also include arranging a further adjustment optical subsystem such that a further adjusted illumination distribution which is more symmetrical compared to the further reference illumination distribution is generated on the sample surface based on optical light emitted by the further illumination subsystem. Various embodiments may include two, three or even more illumination subsystems/further adjustment optical subsystems.

In various embodiments, the adjustment optical subsystem may include an optical element selected from a group comprising a prism, a deflection lens, and a mirror. In various embodiments, the further adjustment optical subsystem comprises a further optical element selected from a group including a prism, a deflection lens, and a mirror. In various embodiments, the adjustment optical subsystem and the further adjustment optical subsystem may include the same type of optical elements. For instance, both the adjustment optical subsystem and the further adjustment optical subsystem may include a prism. In various other embodiments, the adjustment optical subsystem and the further adjustment optical subsystem may include different optical elements. For instance, the adjustment optical system may include a prism, while the further adjustment optical subsystem may include a deflection lens.

In various embodiments, the illumination subsystem and the further illumination subsystem may be the same. For instance, the illumination subsystem and the further illumination subsystem may be configured to emit optical light of the same wavelength. In various other embodiments, the illumination subsystem and the further illumination subsystem may be different. For instance, the optical source of the illumination subsystem and the further optical source of the further illumination subsystem may be configured to emit optical light of different wavelengths.

In various embodiments, the illumination subsystem may include one or more first filters configured to transmit a first predetermined range of wavelengths of optical light. The further illumination subsystem may include one or more second filters configured to transmit a second predetermined range of wavelengths of optical light, which may be the same as or may be different from the first predetermined range of wavelengths.

In various embodiments, the adjusted illumination distribution and the further adjusted illumination distribution may be generated sequentially on the sample surface. In various other embodiments, the adjusted illumination distribution and the further adjusted illumination distribution may be generated concurrently so that the adjusted illumination distribution and the further adjusted illumination distribution overlap to form a resulting illumination distribution on the sample surface.

In various embodiments, the optical light may include visible light, infrared light, and/or ultraviolet light.

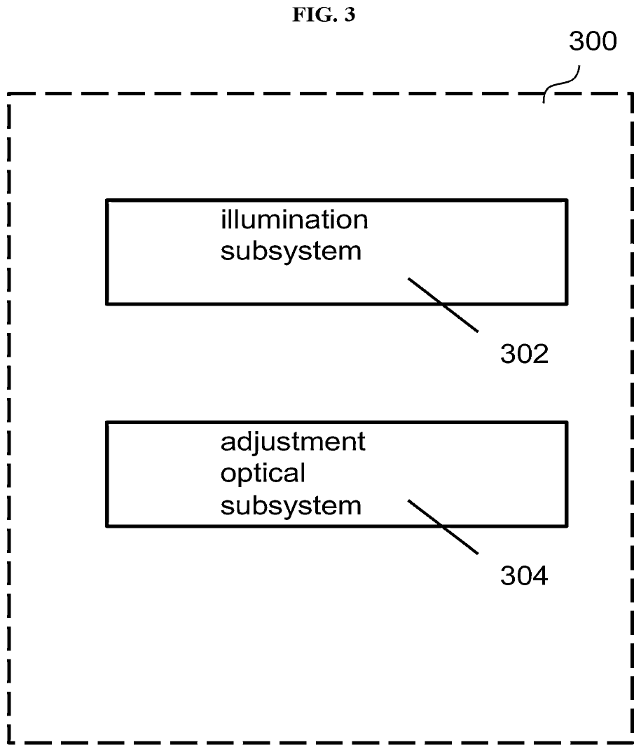

FIG. 3 is a general illustration of an optical system 300 for illuminating a sample surface according to various embodiments. The optical system 300 may include an illumination subsystem 302 including an optical source and at least one lens. The optical system 300 may also include an adjustment optical subsystem 304. The adjustment optical subsystem 304 may be configured to be arranged such that an adjusted illumination distribution generated on the sample surface based on optical light emitted by the illumination subsystem 302 is more symmetrical compared to a reference illumination distribution generated directly on the sample surface based on optical light emitted by the illumination subsystem 302 when the illumination subsystem 302 is arranged such that an optic axis of the illumination subsystem is at an incident angle greater than 0° and less than 90° to a normal of the sample surface.

In other words, the optical system 300 may include an illumination subsystem 302 and an adjustment optical subsystem 304. The illumination subsystem 302 may be arranged with the optic axis at an acute non-zero angle away the normal of the sample surface, such that the illumination distribution provided directly by the subsystem 302 on the sample surface is asymmetrical. The adjustment optical subsystem 304 may be so arranged such that the adjusted illumination distribution generated on the sample surface based on optical light emitted by the illumination subsystem 302 is more symmetrical compared to the illumination distribution provided directly by the subsystem 302.

In various embodiments, the adjustment optical subsystem 304 may include a prism arranged between the illumination subsystem 302 and the sample surface such that optical light from the illumination subsystem 302 is deflected or redirected by the prism to generate the adjusted illumination.

In various embodiments, the adjustment optical subsystem may include a deflection lens arranged between the illumination subsystem 302 and the sample surface such that optical light from the illumination subsystem 302 is deflected or redirected by the deflection lens to generate the adjusted illumination.

In various embodiments, the optical element such the prism or the deflection lens may be held by or mounted onto a suitable adjustable assembly or structure, e.g. an adjustment holder or arm. The adjustable assembly or structure may be moved, e.g. manually or using an actuator/motor. By moving the adjustable assembly or structure, the optical element may be adjusted or moved, thereby arranging the adjustment optical subsystem 304 to generate the adjusted illumination distribution. In various embodiments, the optical element may be held by or mounted onto a fixed assembly or structure. For instance, the prism may be a tunable prism, which may be tuned to change the deflection of optical light onto the sample surface without moving the tunable prism.

In various embodiments, the illumination subsystem 302 may be configured to be moved such that optical light from the illumination subsystem 302 travels away from the sample surface. The adjustment optical subsystem 304 may include a mirror configured such that optical light generated by the illumination subsystem 302 and traveling away from the sample surface is reflected by the mirror to generate a further reference illumination distribution on the sample surface. The mirror may be configured to be tilted such that the adjusted illumination distribution is more symmetrical compared to the reference illumination distribution and more symmetrical compared to the further reference illumination distribution.

In various embodiments, the illumination subsystem 302 may be configured to be moved such that the optic axis is parallel to the sample surface. The adjustment optical subsystem 304 may include a mirror configured such that optical light generated by the illumination subsystem 302 and traveling along the optic axis is reflected by the mirror to generate a further reference illumination distribution on the sample surface. The mirror may be configured to be tilted such that the adjusted illumination distribution is more symmetrical compared to the reference illumination distribution and more symmetrical compared to the further reference illumination distribution.

In various embodiments, the mirror may be held by or mounted onto a suitable adjustable assembly or structure, e.g. an adjustment holder or arm. The suitable adjustable assembly or structure may be moved, e.g. manually or using an actuator/motor. By moving the suitable adjustable assembly or structure, the mirror may be tilted or moved, thereby arranging the adjustment optical subsystem 304 to generate the adjusted illumination distribution. The illumination subsystem 302 may be held by or mounted onto a further suitable adjustable assembly or structure, e.g. a further adjustment holder or arm. The illumination subsystem 302 may be moved by moving the further suitable adjustable assembly or structure.

In various embodiments, the illumination subsystem 302 may be configured to be moved such that the optic axis is parallel to the sample surface. The adjustment optical subsystem 304 may include a first mirror and a second mirror such that optical light generated by the illumination subsystem 302 and traveling along the optic axis is reflected by the first mirror onto the second mirror and further reflected by the second mirror to generate a further reference illumination distribution on the sample. The second mirror may be configured to be tilted such that the adjusted illumination distribution is more symmetrical compared to the reference illumination distribution and more symmetrical compared to the further reference illumination distribution.

In various embodiments, the second mirror may be held by or mounted onto a suitable adjustable assembly or structure, e.g. an adjustment holder or arm. The suitable adjustable assembly or structure may be moved, e.g. manually or using an actuator/motor. By moving the suitable adjustable assembly or structure, the second mirror may be tilted or moved, thereby arranging the adjustment optical subsystem 304 to generate the adjusted illumination distribution. The illumination subsystem 302 may be held by or mounted onto a further suitable adjustable assembly or structure, e.g. a further adjustable holder or arm. The illumination subsystem 302 may be moved by moving the further suitable adjustable assembly or structure. In various embodiments, the first mirror may be held or mounted onto a fixed assembly or structure, e.g. a fixed holder or arm, and may not be movable. In various other embodiments, the first mirror may be held or mounted onto another suitable adjustable assembly or structure, e.g. an adjustment holder or arm. However, the other suitable adjustable assembly or structure holding the first mirror may simply not be moved during operation.

In various embodiments, the illumination subsystem 302 may include a housing to hold the optical source and the at least one lens. In various embodiments, the illumination subsystem 302 may include a filter. The filter may allow optical light of certain wavelengths to pass through. In this manner, the illumination subsystem 302 may be configured to emit optical light of certain wavelengths, i.e. spectral emission, due to the filter. Various embodiments may relate to changing filters or moving the filter to change the wavelengths of light emitted by the illumination subsystem 302.

In various embodiments, the optical source may be configured to be moved such that an area of a central spot of illumination or region of symmetry within the adjusted illumination distribution is increased. The optical source may be mounted to an adjustable or movable structure of the housing such that the optical source may be moved to increase the area of the central spot of illumination or region of symmetry.

In various embodiments, the optical system 300 may include a further illumination subsystem including an optical source and at least one lens. The optical system 300 may also include a further adjustment optical subsystem. The further adjustment optical subsystem may be configured to be arranged such that a further adjusted illumination distribution generated on the sample surface based on optical light emitted by the further illumination subsystem is more symmetrical compared to a further reference illumination distribution generated directly on the sample surface based on optical light emitted by the further illumination subsystem when the further illumination subsystem is arranged such that an optic axis of the further illumination subsystem is at an incident angle greater than 0° and less than 90° to a normal of the sample surface. Various embodiments may include two, three or even more illumination subsystems/further adjustment optical subsystems. In various embodiments, the optical system 300 may include a structure or assembly, such as a rotating turret, to hold or mount the multiple illumination subsystems.

In various embodiments, the adjustment optical subsystem 304 may include an optical element selected from a group comprising a prism, a deflection lens, and a mirror. The further adjustment optical subsystem may include a further optical element selected from a group comprising a prism, a deflection lens, and a mirror. The optical element may be held by a first suitable adjustable assembly or structure, while the further optical element may be held by a second suitable adjustable assembly or structure.

In various embodiments, the adjusted illumination distribution and the further adjusted illumination distribution may be generated sequentially on the sample surface. In various other embodiments, the adjusted illumination distribution and the further adjusted illumination distribution may be generated concurrently so that the adjusted illumination distribution and the further adjusted illumination distribution overlap to form a resulting illumination distribution on the sample surface.

In various embodiments, the optical system 300 may include a camera configured to capture or detect the adjusted illumination distribution, the further adjusted illumination distribution, the reference illumination distribution, and/or the further reference illumination distribution.

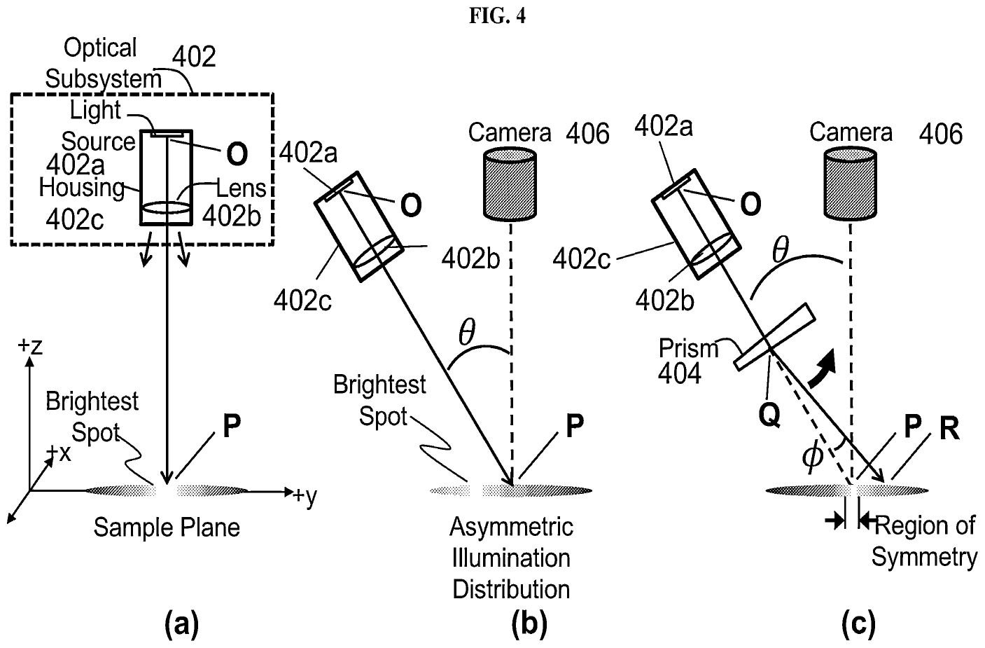

FIG. 4 is a schematic showing a method of achieving greater illumination symmetry on a sample surface according to various embodiments. FIG. 4(a) and FIG. 4(b) may be similar to FIG. 1(a) and FIG. 1(b), respectively. The optical system may include an illumination subsystem 402 including an optical source 402a, at least one lens 402b and the housing 402c. The illumination subsystem 402 may generate a symmetric illumination distribution on the sample surface when the optic axis is along the normal of the sample plane, as shown in FIG. 4(a). As shown in FIG. 4(b), when the illumination subsystem 402 is arranged such that the optic axis is at an angle greater than 0° and less than 90° to a normal of the sample surface, an asymmetric illumination distribution may be seen on the sample surface. A camera 406 may be used to capture the illumination distributions formed on the sample surface.

As seen in FIG. 4(c), a prism 404 may be used to form an adjusted illumination distribution which is more symmetrical compared to the asymmetrical illumination distribution shown in FIG. 4(b), which may be referred to as a reference illumination distribution. By using the prism 404, the ray originating at O may be deflected a point Q towards point R, by way of refraction of the ray inside the prism 404. The prism 404 may be made of any material that is transparent to optical light, such as glass, plastic, or a fluid such as water which may be held by a thin transparent membrane. The prism may alternatively be referred to as a wedge. A glass prism may be known as a glass wedge, a plastic prism may be known as a plastic wedge etc.

The prism 404 may be characterized by having a thickness that varies from a first end to a second end opposite the first end. For instance, as shown in FIG. 4(c), the left end of the prism 404 may be thinner than the right end, which results in a wedge angle (sometimes called the “apex angle”) for the prism 404. Therefore, if a variety of prisms with different wedge angles are available, then a variety of deflection angles ϕ may be achieved. Hence, depending on the specific design of the illumination subsystem 402 and choice of the oblique angle θ, one may use different prisms with different wedge angles to deflect the ray originating from O in order to achieve greater symmetry of illumination about point P at the sample plane. This may be advantageous over the method shown in FIG. 1(c), as the direction of the ray originating from O may be varied without physical motion of the illumination subsystem 402. The prism 404 may be a tunable prism. For example, if the prism 404 contains fluid held by a thin transparent membrane, it may be possible to vary the prism's wedge angle without changing the prism 404 to a different prism. Such a prism may be called a “tunable prism”. One tunable prism is TP-12-16 from Optotune.

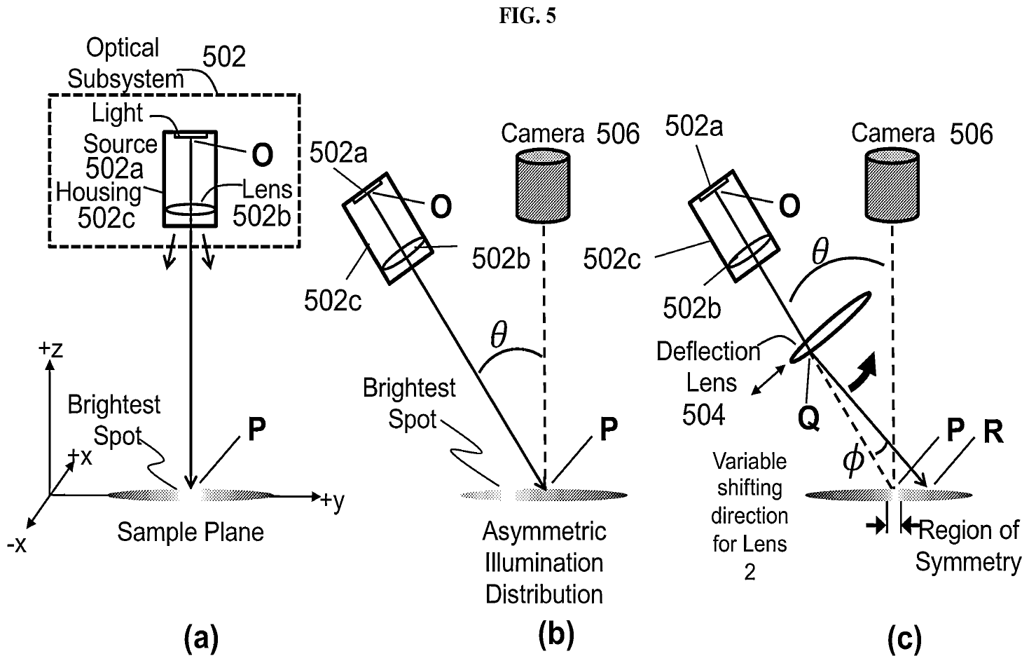

FIG. 5 is a schematic showing a method of achieving greater illumination symmetry on a sample surface according to various other embodiments. FIG. 5(a) and FIG. 5(b) may be similar to FIG. 1(a) and FIG. 1(b), respectively. The optical system may include an illumination subsystem 502 including an optical source 502a, at least one lens 502b and the housing 502c. The illumination subsystem 502 may generate a symmetric illumination distribution on the sample surface when the optic axis is along the normal of the sample plane, as shown in FIG. 5(a). As shown in FIG. 5(b), when the illumination subsystem 502 is arranged such that the optic axis is at an angle greater than 0° and less than 90° to a normal of the sample surface, an asymmetric illumination distribution may be seen on the sample surface. A camera 506 may be used to capture the illumination distributions formed on the sample surface.

As seen in FIG. 5(c), a deflection lens 504 may be used to form an adjusted illumination distribution which is more symmetrical compared to the asymmetrical illumination distribution shown in FIG. 5(b), which may be referred to as a reference illumination distribution. The ray originating at O may be made to pass through a section of the deflection lens 504. The deflection lens 504 may be any type of positive powered lens, such as a plano-convex lens, a bi-convex lens, or a cylindrical convex lens. The ray originating at O may be made to be refracted by a section of the deflection lens 504 such that the ray is deflected at point Q towards point R. The section of the deflection lens 504 that provides the ray deflection may be located between the center and the edge of the deflection lens 504. The section of the deflection lens 504 may therefore act effectively as a prism. In fact, by shifting the deflection lens 504 along either direction indicated by the thin double-sided arrows, the deflection angle ϕ may be varied, because different sections of the deflection lens 504 may act as prisms with different wedge angles, due to the curved surfaces of the deflection lens 504. It may not be required that the deflection lens 504 be located outside of the illumination subsystem 502. In various embodiments, the deflection lens 504 may be located inside the illumination subsystem 502 (i.e., mounted within the housing 502c together with the lens 502b and source 502a). In various other embodiments, the deflection lens 504 may be arranged external to the illumination subsystem 502 (i.e. outside of housing 502c). In various embodiments, the optical system, i.e. the adjustment optical subsystem, may include more than a single deflection lens 504. Each deflection lens may be shifted in the direction of the thin double-sided arrows shown beside the deflection lens 504 in FIG. 5(c).

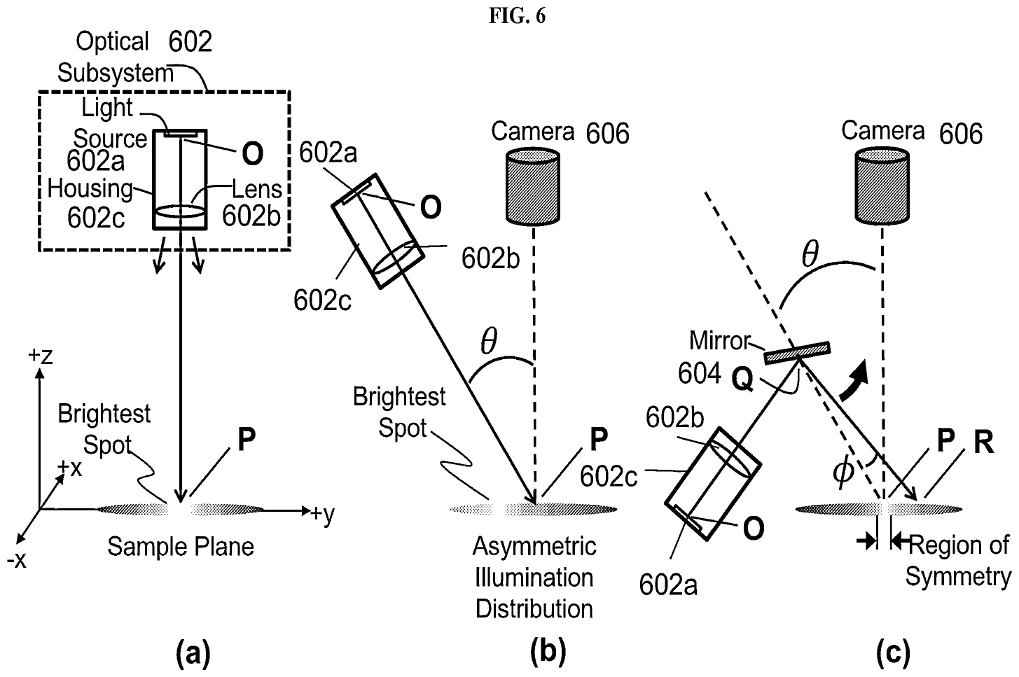

FIG. 6 is a schematic showing a method of achieving greater illumination symmetry on a sample surface according to yet various other embodiments. FIG. 6(a) and FIG. 6(b) may be similar to FIG. 1(a) and FIG. 1(b), respectively. The optical system may include an illumination subsystem 602 including an optical source 602a, at least one lens 602b and the housing 602c. The illumination subsystem 602 may generate a symmetric illumination distribution on the sample surface when the optic axis is along the normal of the sample plane, as shown in FIG. 6(a). As shown in FIG. 6(b), when the illumination subsystem 602 is arranged such that the optic axis is at an angle greater than 0° and less than 90° to a normal of the sample surface, an asymmetric illumination distribution may be seen on the sample surface. A camera 606 may be used to capture the illumination distributions formed on the sample surface.

As seen in FIG. 6(c), a mirror 604 may be used to form an adjusted illumination distribution which is more symmetrical compared to the asymmetrical illumination distribution shown in FIG. 6(b), which may be referred to as a reference illumination distribution. The illumination subsystem 602 may be arranged or moved such that optical light from the illumination subsystem travels 602 away from the sample surface. The mirror 604 may be arranged at an initial horizontal position parallel to the sample surface to reflect the optical light back towards the sample surface to form a further reference illumination distribution. The mirror 604 may then be tilted by an amount ϕ/2 (i.e., half of the deflection angle ϕ) from the initial horizontal position, such that the ray originating at O is deflected by an amount ϕ at point Q. When the mirror 604 is not tilted by an amount ϕ/2, the ray originating from O may ordinarily reflect off the mirror 604 and land at position P. When the mirror 604 is tilted by an amount ϕ/2, the ray originating from O may be made to be deflected towards a position R such that there is greater symmetry of illumination about P at the sample plane. The adjusted illumination distribution generated after tilting of the mirror 604 by the amount ϕ/2 may be more symmetrical compared to the reference illumination distribution, and more symmetrical compared to the further reference illumination distribution. One advantage of this method compared to that shown in FIG. 1(c) is that variable adjustment of the ray deflection may be provided by tilting the mirror rather than by adjusting the tilt for the entire illumination subsystem 602.

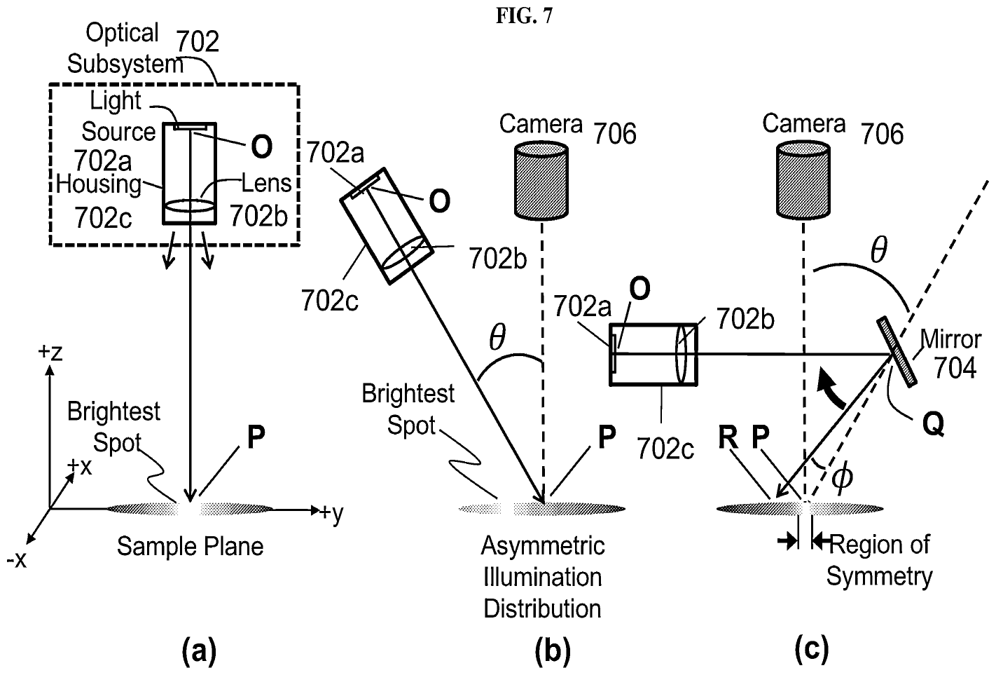

FIG. 7 is a schematic showing a method of achieving greater illumination symmetry on a sample surface according to yet various other embodiments. FIG. 7(a) and FIG. 7(b) may be similar to FIG. 1(a) and FIG. 1(b), respectively. The optical system may include an illumination subsystem 702 including an optical source 702a, at least one lens 702b and the housing 702c. The illumination subsystem 702 may generate a symmetric illumination distribution on the sample surface when the optic axis is along the normal of the sample plane, as shown in FIG. 7(a). As shown in FIG. 7(b), when the illumination subsystem 702 is arranged such that the optic axis is at an angle greater than 0° and less than 90° to a normal of the sample surface, an asymmetric illumination distribution may be seen on the sample surface. A camera 706 may be used to capture the illumination distributions formed on the sample surface.

As seen in FIG. 7(c), a mirror 704 may be used to form an adjusted illumination distribution which is more symmetrical compared to the asymmetrical illumination distribution shown in FIG. 7(b), which may be referred to as a reference illumination distribution. The illumination subsystem 602 may be arranged or moved such that the illumination subsystem 702 is horizontal, i.e. the optic axis of the illumination subsystem 702 is parallel to the sample surface. When the illumination subsystem 702 is horizontal, risk of dust falling onto the one or more lens 702b of the illumination subsystem 702 may be reduced. Further, as the reflective surface (or reflecting surface) of the mirror 704 faces downwards towards the sample surface, there is also less risk of dust falling onto the reflective surface (or reflecting surface) of the mirror 704. The mirror 704 may be arranged at an initial position/orientation to reflect the optical light back towards the sample surface (along a line at angle θ from normal of sample surface) to form a further reference illumination distribution. The ray originating from O may be reflected by the mirror 704 at point Q to point P. The mirror 704 may be tilted by an amount ϕ/2 from the initial position/orientation such that the ray originating at O is deflected by an amount ϕ at point Q towards point R to generate the adjusted illumination distribution which is more symmetrical compared to the reference illumination distribution, and more symmetrical compared to the further reference illumination distribution.

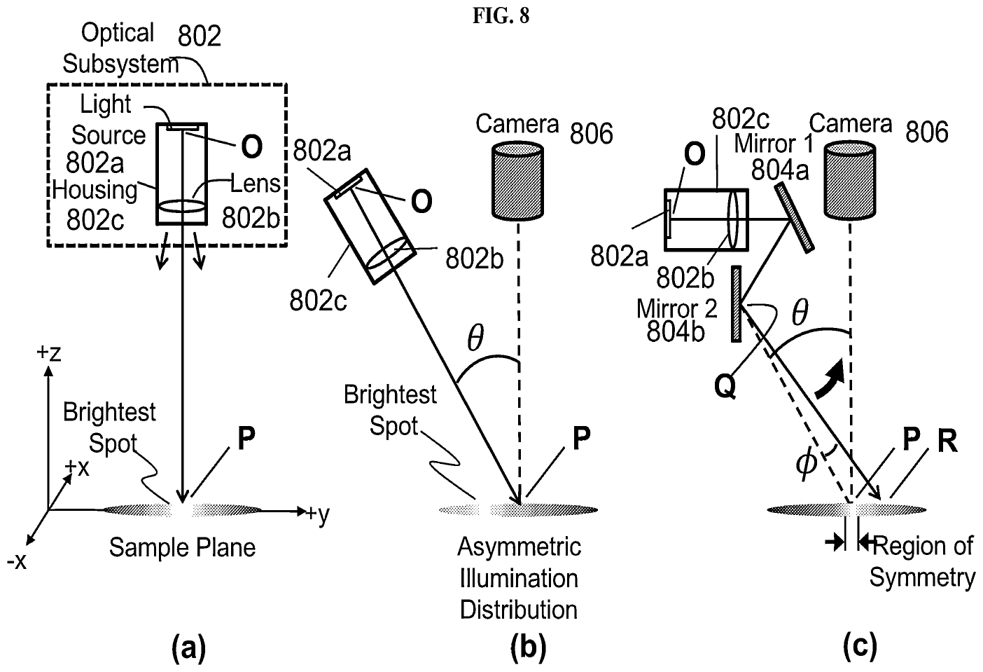

FIG. 8 is a schematic showing a method of achieving greater illumination symmetry on a sample surface according to yet various other embodiments. FIG. 8(a) and FIG. 8(b) may be similar to FIG. 1(a) and FIG. 1(b), respectively. The optical system may include an illumination subsystem 802 including an optical source 802a, at least one lens 802b and the housing 802c. The illumination subsystem 802 may generate a symmetric illumination distribution on the sample surface when the optic axis is along the normal of the sample plane, as shown in FIG. 8(a). As shown in FIG. 8(b), when the illumination subsystem 802 is arranged such that the optic axis is at an angle greater than 0° and less than 90° to a normal of the sample surface, an asymmetric illumination distribution may be seen on the sample surface. A camera 806 may be used to capture the illumination distributions formed on the sample surface.

As seen in FIG. 8(c), a first mirror 804a and a second mirror 804b may be used to form an adjusted illumination distribution which is more symmetrical compared to the asymmetrical illumination distribution shown in FIG. 8(b), which may be referred to as a reference illumination distribution. Optical light generated by the illumination subsystem 802 and traveling along the optic axis of the illumination subsystem 802 may be reflected by the first mirror 802a onto the second mirror 802b, and further reflected by the second mirror 802b to generate a further reference illumination distribution on the sample surface. The two mirrors 804a, 804b may be applied to direct the ray originating from O towards the sample surface, but only the second mirror 804b may be used to deflect this ray towards point R. Before the second mirror 804b is tilted (i.e. when the second mirror 804b is at an initial position/orientation), the ray originating at O may be directed towards point P, and a further reference illumination distribution may be generated at the sample surface. After the second mirror 804b is tilted by an amount ϕ/2 from an initial position/orientation, the ray originating at O may be deflected by an amount ϕ at point Q towards point R, and an adjusted illumination distribution may be generated at the sample surface. The adjusted illumination distribution may be more symmetrical compared to the reference illumination distribution, and more symmetrical compared to the further reference illumination distribution.

The central spot in the symmetrical adjusted illumination distributions shown in FIG. 1(c), FIG. 4(c), FIG. 5(c), FIG. 6(c), FIG. 7(c), and FIG. 8(c) may be relatively narrow. The central spot may be a region within the adjusted illumination distribution which shows greater symmetry compared to the remaining region of the adjusted illumination distribution, and may also be referred to as a region of symmetry. The boundary separating the central spot and the remaining region may be fuzzy and may not be well-defined.

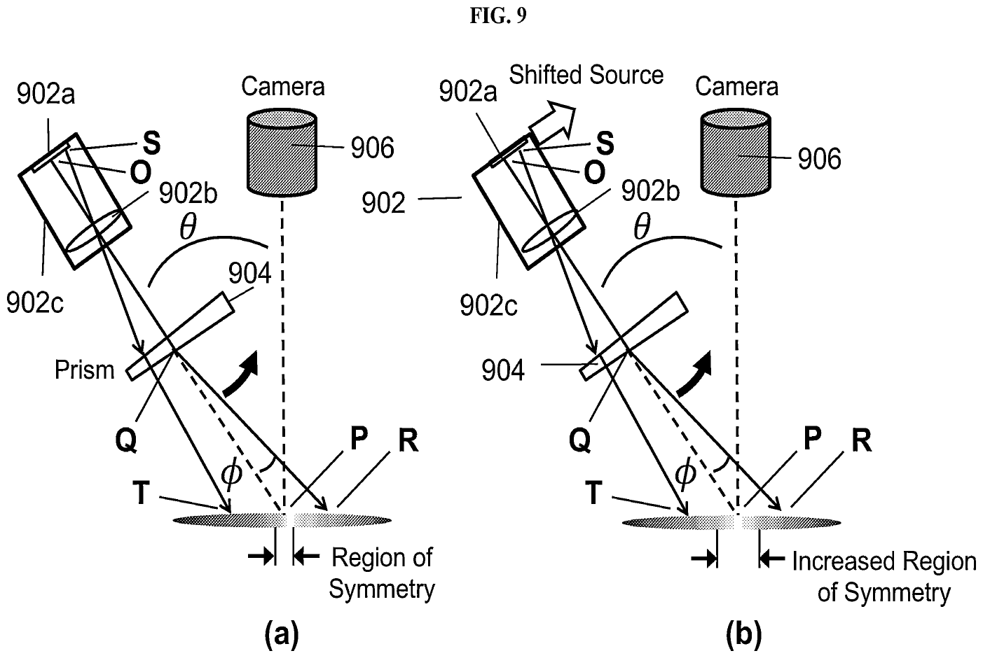

FIG. 9 is a schematic illustrating the shifting of an optical source across a mounting plane in the illumination subsystem 902 to increase the region of symmetry of the illumination distribution on the sample surface according to various embodiments. FIG. 9(a) may correspond to FIG. 4(c) in which an adjusted illumination distribution is generated on the sample surface based on optical light emitted by the illumination subsystem 902, and deflected by the prism 904. The illumination subsystem 902 may include an optical source 902a, at least one lens 904b, and a housing 904c. The optical system may also include a camera 906 to image the illumination distribution.

As shown in FIG. 9(a), the ray originating from point S (which is at the edge of the source 902a) may travel through the prism and may land at point T at the sample surface. As this ray originates from the edge of the source 902a, the region to the left of point T may be dark. By shifting the source in the direction shown in FIG. 9(b), more light may be provided at point S, which enables greater flux to be at point T. In other words, the amount of illumination at position T on the sample surface may be increased. This may help to increase the area of the central spot or region of symmetry, which is illustrated in FIG. 9(b). Since all of the methods shown in FIG. 4(c), FIG. 5(c), FIG. 6(c), FIG. 7(c), and FIG. 8(c) relate to providing an effectively equivalent deflection of the ray originating from O, the method of shifting the source 702a as illustrated in FIG. 9(c) may also be applied to the methods shown in FIG. 4(c), FIG. 5(c), FIG. 6(c), FIG. 7(c), and FIG. 8(c).

Various embodiments may include more than one illumination subsystem. For instance, if illumination at a sample surface is required to be of a specific wavelength or wavelength band, additional illumination subsystems, each with an optical source of different spectral emission (i.e. emitting optical light of different wavelengths) may be included and mounted beside one another. An actuation mechanism, e.g. a motor, may be used to scan each illumination subsystem such that each illumination subsystem may sequentially illuminate the sample surface. A filter that allows a preferred spectral transmission may be mounted in front of each illumination subsystem. The filter may be an interference filter, a dichroic filter, or an absorptive color filter.

Conventionally, the filters may be mounted on a rotating mechanical assembly called a “filter wheel”. By rotating the filter wheel, different filters may be selected to be used in front of a single illumination subsystem. Sometimes, it may be required to switch the filters without using such a mechanical assembly. This may be because the motions due to the mechanical assembly generate unwanted vibrations, or that time is required for the filter wheel to turn from one filter to another filter, which may not be desirable.

It may be possible to avoid mechanical motion for switching different filters if multiple optical subsystems (each mounted with a filter) are used to sequentially illuminate a sample surface. In this case, the sources of the illumination subsystems may be switched on one at a time. Additionally or alternately, each illumination subsystem including a filter may be made to illuminate at different magnitudes of the angle θ. Since each illumination subsystem with the filter illuminates at a different angle θ, it may be required to apply different deflections ϕ to produce symmetric illumination at the sample plane.

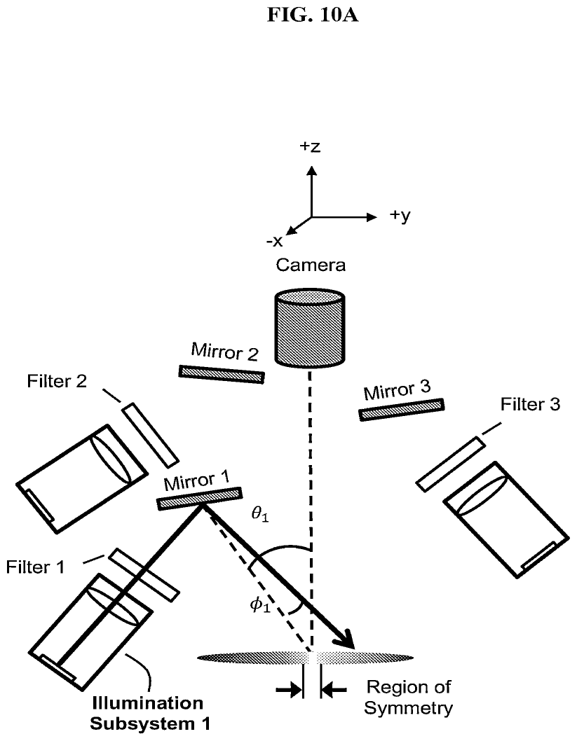

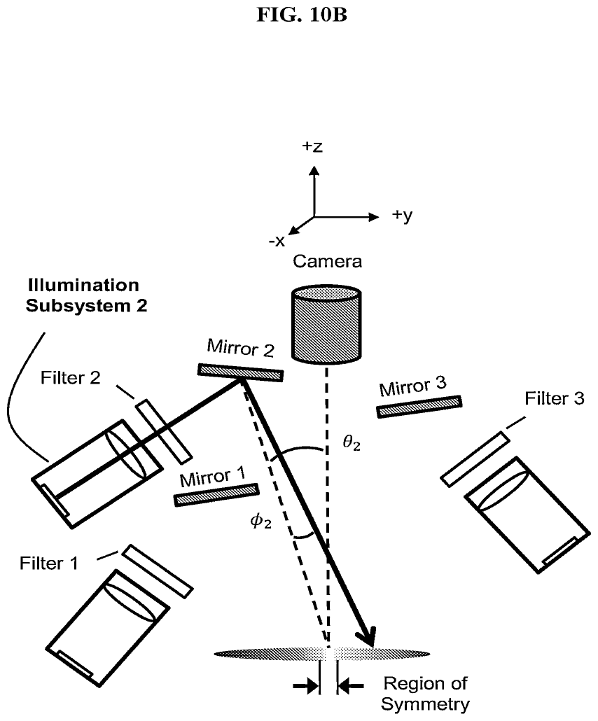

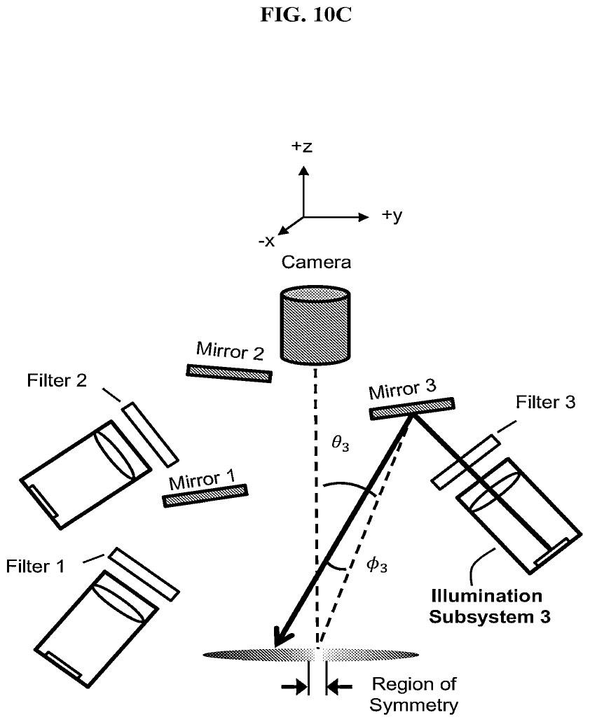

FIGS. 10A-C illustrate the sequential illumination onto a sample surface using different illumination subsystems 1-3 according to various embodiments. Each of the illumination subsystem may include an optical source, at least one lens, a housing, as well as a filter. In addition, each optical illumination subsystem may be used in conjunction with a different adjustment optical subsystem. Each adjustment optical subsystem may include one or more optical elements such as a mirror as shown in FIG. 10A-C. In various embodiments, each adjustment optical subsystem may include one or more mirrors, one or more deflection lenses, one or more prism, or any combination thereof. As shown in FIGS. 10A-C, the filter of each illumination subsystem may be placed between the lens of the illumination subsystem and the associated adjustment optical subsystem.

FIG. 10A is a schematic showing illumination subsystem 1 may be activated (i.e. turned “on”) while the illumination subsystems 2 and 3 may be deactivated (i.e. turned “off”) according to various embodiments. FIG. 10B is a schematic showing illumination subsystem 2 may be activated (i.e. turned “on”) while the illumination subsystems 1 and 3 may be deactivated (i.e. turned “off”) according to various embodiments. FIG. 10C is a schematic showing illumination subsystem 3 may be activated (i.e. turned “on”) while the illumination subsystems 1 and 2 may be deactivated (i.e. turned “off”) according to various embodiments.

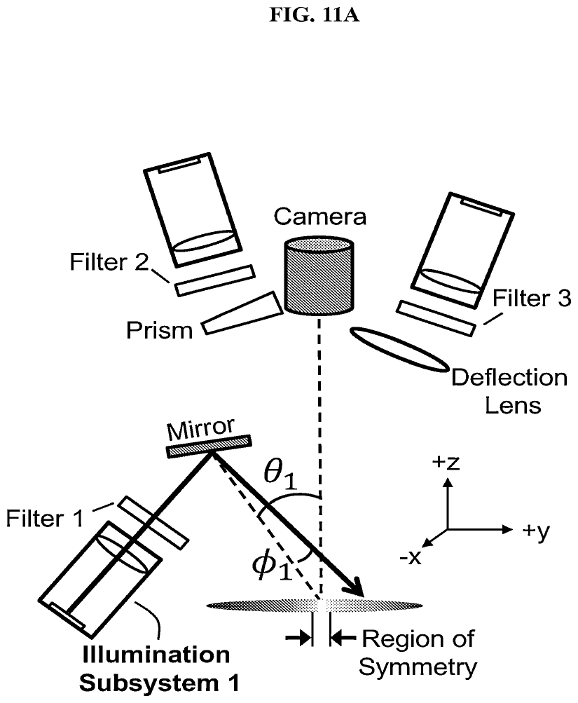

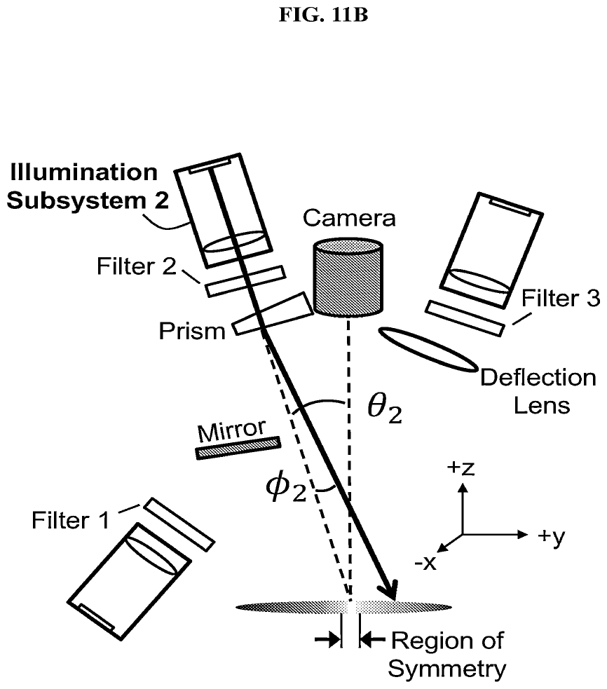

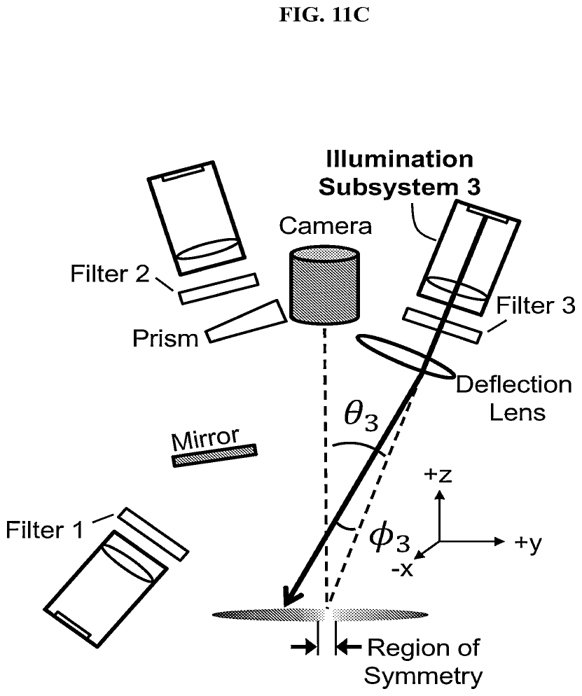

In various embodiments, the different adjustment optical subsystem may include different types of optical elements. The deflection magnitude ϕ required may also be different. As shown in FIGS. 11A-C, illumination subsystem 1 may be used in conjunction with a mirror, illumination subsystem 2 may be used in conjunction with a prism, while illumination subsystem 3 may be used in conjunction with a deflection lens.

FIG. 11A is a schematic showing illumination subsystem 1 may be activated (i.e. turned “on”) while the illumination subsystems 2 and 3 may be deactivated (i.e. turned “off”) according to various embodiments. FIG. 11B is a schematic showing illumination subsystem 2 may be activated (i.e. turned “on”) while the illumination subsystems 1 and 3 may be deactivated (i.e. turned “off”) according to various embodiments. FIG. 11C is a schematic showing illumination subsystem 3 may be activated (i.e. turned “on”) while the illumination subsystems 1 and 2 may be deactivated (i.e. turned “off”) according to various embodiments.

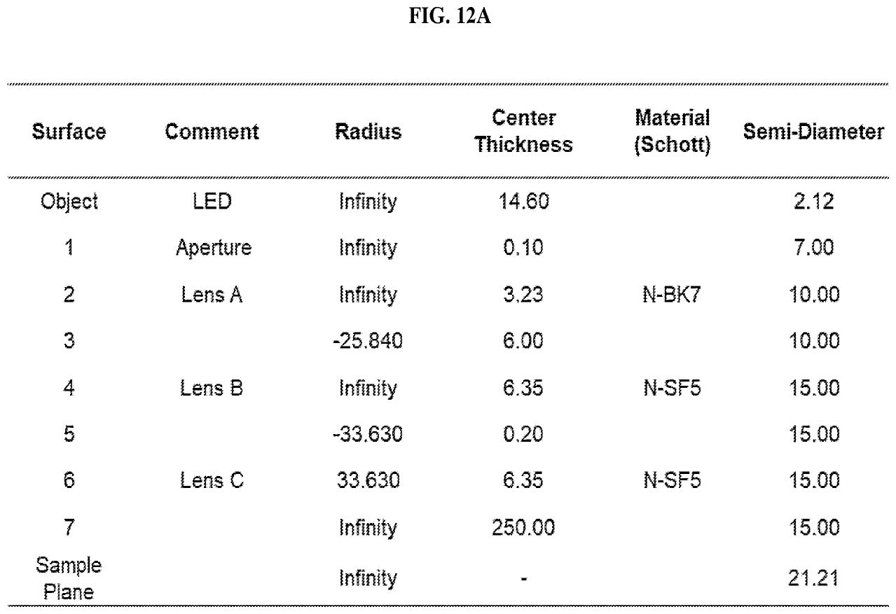

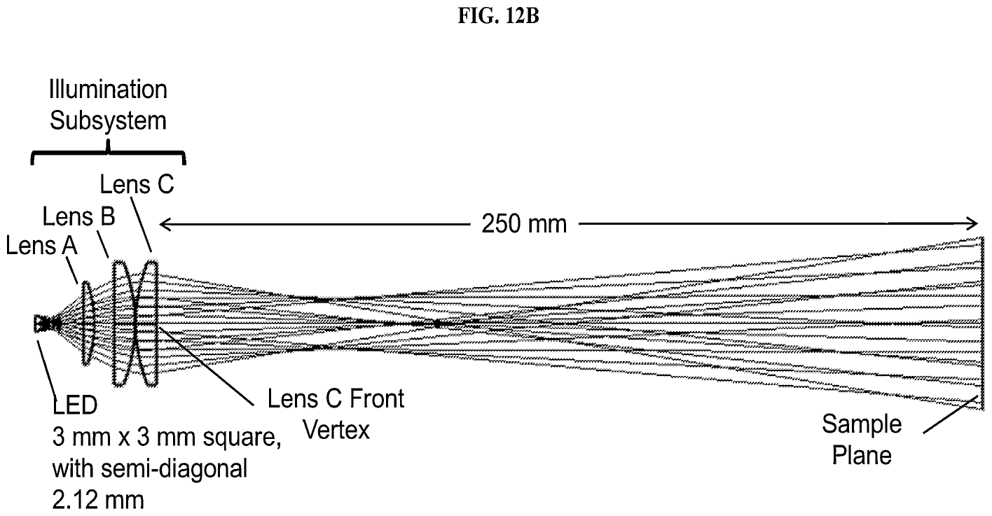

FIG. 12A is a table showing a lens prescription for an illumination subsystem according to various embodiments. The illumination subsystem may be used for the systems and/or methods, such as that illustrated in FIGS. 4-9, 10A-C, and 11A-C. The units for radius, center thickness and semi-dimeter are in milli-meters (mm).

In FIG. 12A, Surface 1 is labelled as “Aperture”, which, in optical design terms, refers to the Stop of the optical subsystem. Surface 1 may therefore be a mechanical spacer made into an annulus, with an opening of diameter 14 mm (i.e., twice of the 7 mm semi-diameter for Surface 1), and an outer diameter of any suitable value that would fit inside a housing for the illumination subsystem. The Stop may block unwanted light from the light emitting diode (LED), which is the surface prior to Surface 1. For this example, the LED may be assumed to have a square area of 3 mm×3 mm, and may emit a Lambertian intensity profile with total flux of 1 Watt, at a monochromatic wavelength equal to 580 nanometers (nm).

FIG. 12B is a schematic illustrating the horizontal layout of an illumination subsystem having the lens prescription as shown in FIG. 12A according to various embodiments. As highlighted earlier, the object is a LED whose surface area is a 3 mm×3 mm square, so its full diagonal is 3 times the square root of 2, which is about 4.24 mm. This corresponds to the semi-diameter of 2.12 mm shown in FIG. 12A (half of 4.24 mm).

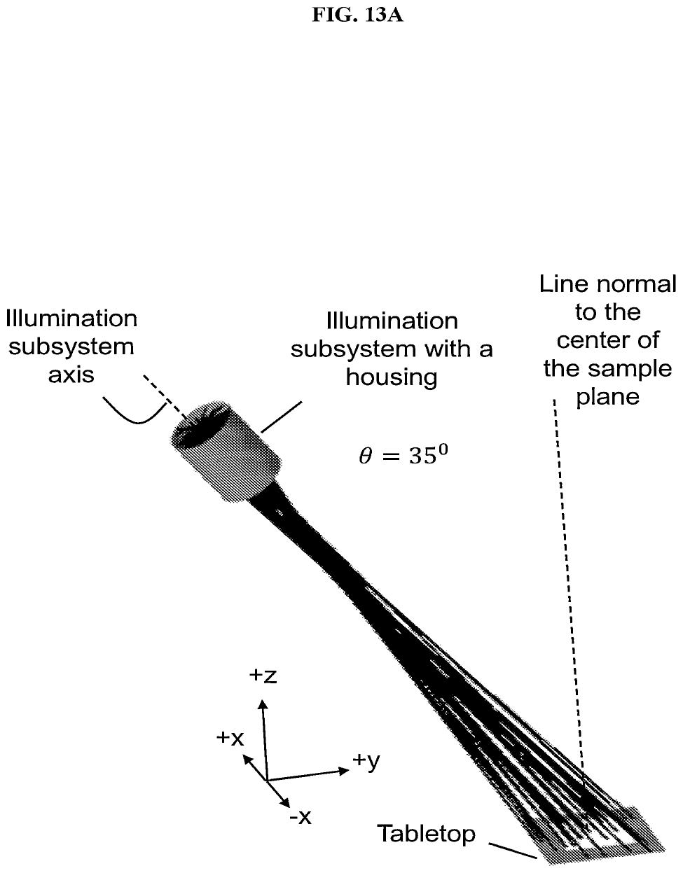

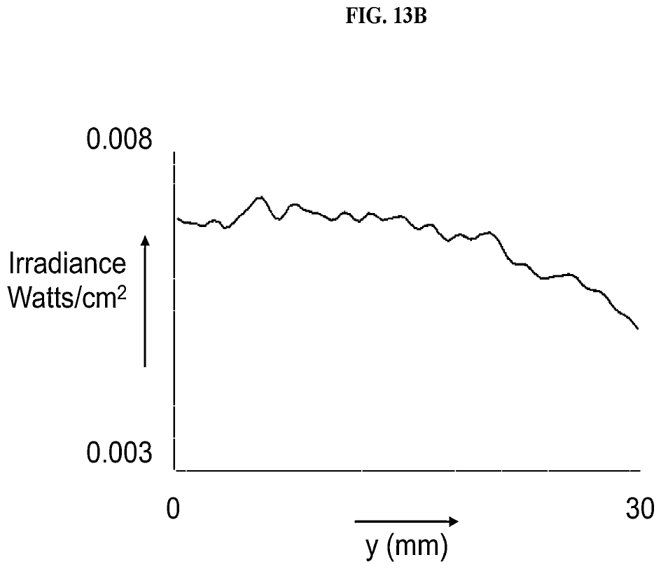

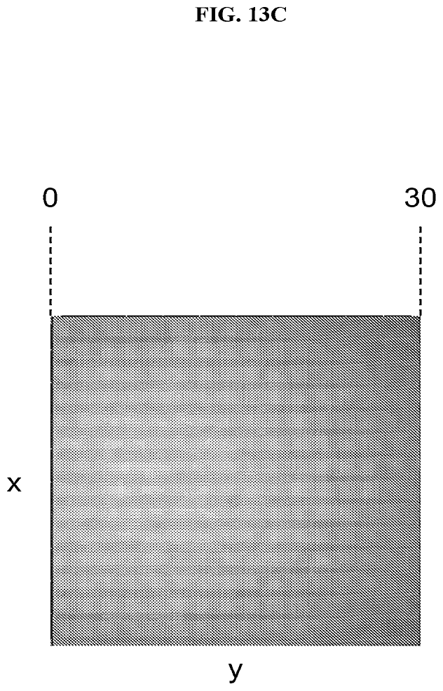

FIG. 13A is a schematic showing the illumination subsystem as illustrated in FIG. 12B according to various embodiments being mounted such that the illumination subsystem axis (optic axis) is at an oblique angle (θ) of 35° from the dotted line, which indicates the normal to the sample surface. In other words, the optic axis of the illumination subsystem intersects with the normal line to the center of the sample plane, and the angle between the two lines is 35 degrees. The illumination subsystem has been modelled with a housing enclosing the optical source and the lenses. The front of the housing is coincident with the front vertex of Lens C. Hence, the distance from the front of the housing to the center of the sample plane is 250 mm. Equivalently, the distance from the front vertex of Lens C to the center of the sample plane is 250 mm.

FIG. 13B is a plot of irradiance (in watts per square centimeters or Watts/cm²) as a function of distance along the y-axis (in millimeters or mm) showing the resulting irradiance profile generated by the system shown in FIG. 13A along the y-axis of the sample surface. FIG. 13C is a grey scale surface plot showing the illumination distribution generated by the system shown in FIG. 13A at the sample surface along the x-axis and the y-axis. The x- and y-coordinates in a surface plot indicate locations across the illuminated sample surface. At each location (x, y) in the surface plot, the irradiance at the location is indicated by the greyscale “brightness” level at that location.

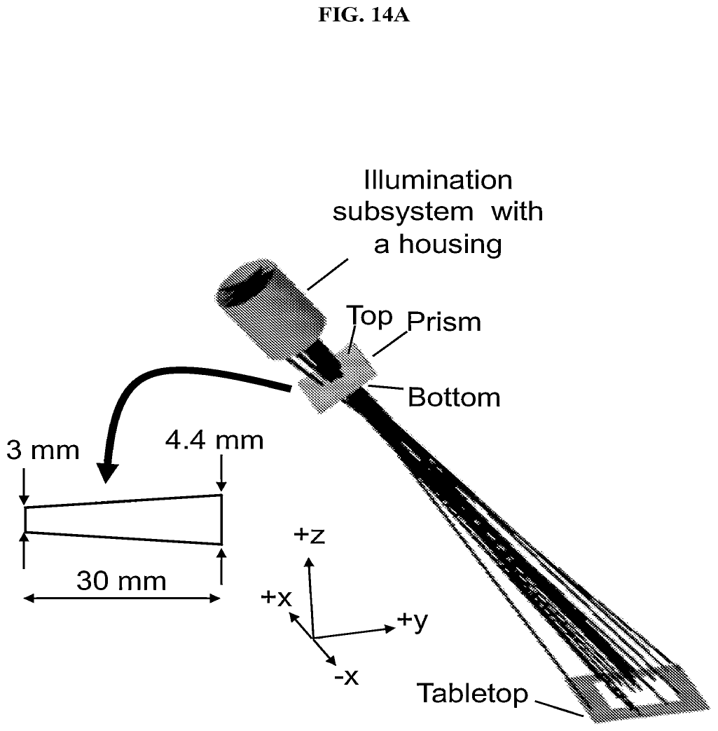

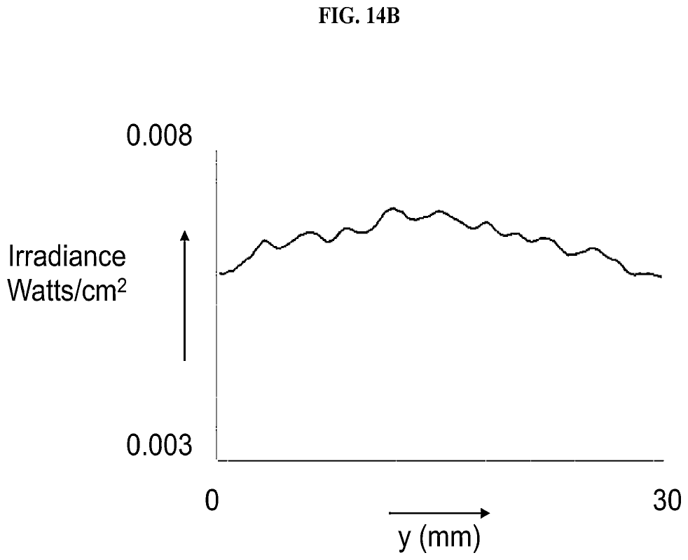

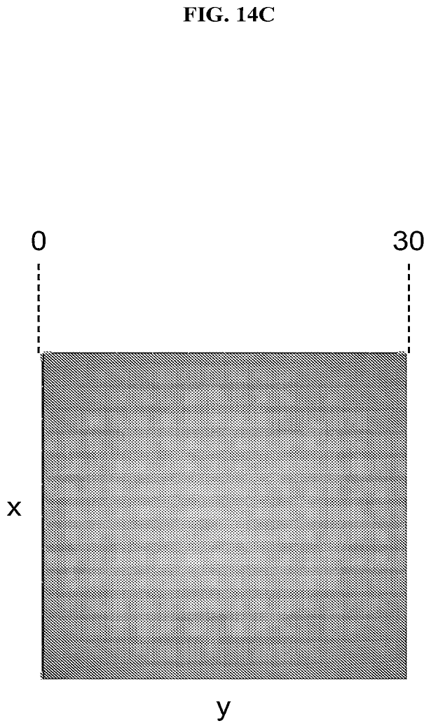

FIG. 14A is a schematic showing the illumination subsystem as illustrated in FIG. 12B according to various embodiments used in conjunction with a prism according to various embodiments. The top side of the prism is mounted 30 mm in front of the front vertex of Lens C. The prism material is assumed to be made of Schott N-BK7®, whose refractive index at 588 nm is about 1.5168. The front and back faces of the prism is 30 mm in the x-dimension, and 30 mm in the y-dimension. The wedge or apex angle of the prism is 2.67 degrees, yielding a thickness of 3 mm at one end of the prism, and a thickness of 4.4 mm at the other end of the prism. This prism is assumed to be a custom-made component, and may take on other values for its wedge angle.

FIG. 14B is a plot of irradiance (in watts per square centimeters or Watts/cm²) as a function of distance along the y-axis (in millimeters or mm) showing the resulting irradiance profile generated by the system shown in FIG. 14A along the y-axis of the sample surface. FIG. 14C is a grey scale surface plot showing the illumination distribution generated by the system shown in FIG. 14A at the sample surface along the x-axis and the y-axis.

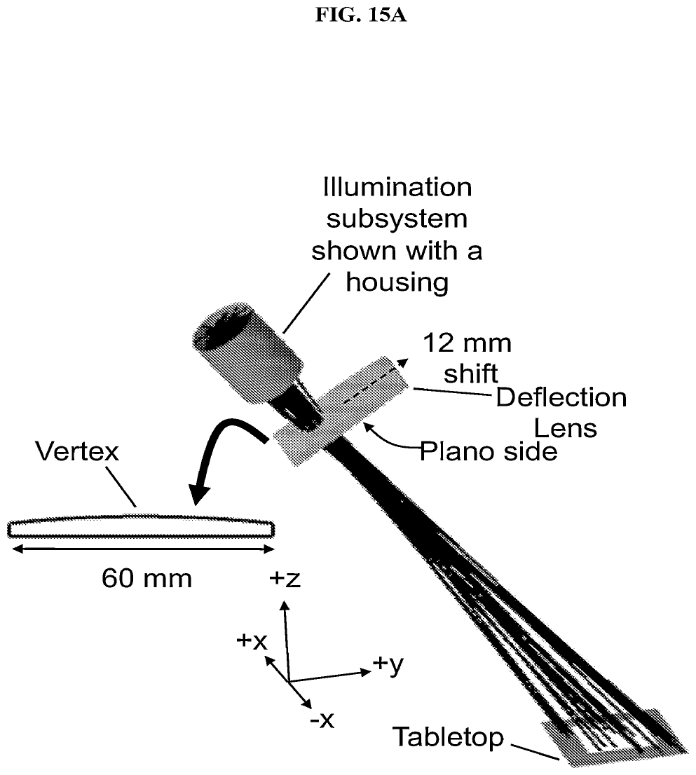

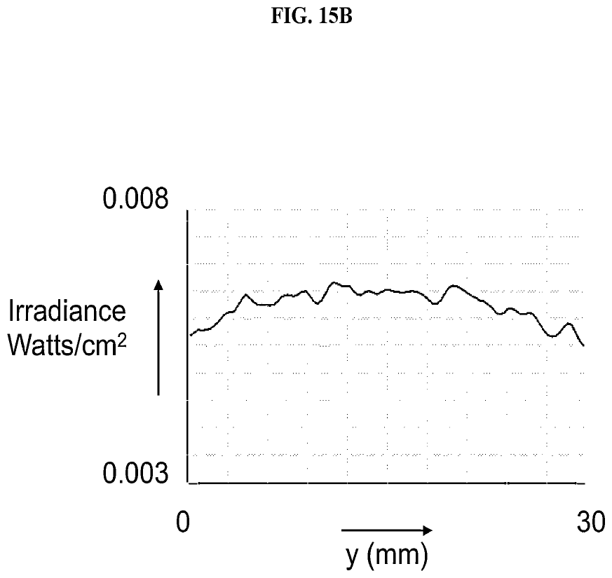

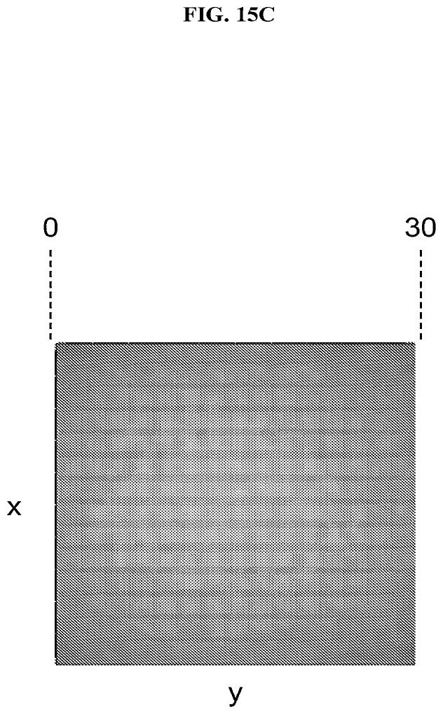

FIG. 15A is a schematic showing the illumination subsystem as illustrated in FIG. 12B according to various embodiments used in conjunction with a deflection lens according to various embodiments. In this example, the deflection lens is a plano-convex cylindrical lens whose plano side faces the sample plane. The convex side faces the housing, and the vertex of the convex side is mounted 30 mm in front of the front vertex of Lens C, and is shifted 12 mm in the direction of the dotted arrow shown. The deflection lens is 30 mm in width in the x-dimension, and 60 mm in length in the y-dimension. The radius of curvature of the convex surface is 250 mm. The material of the deflection lens is assumed to be Schott N-BK7®, with refractive index of 1.5168 at 588 nm.

FIG. 15B is a plot of irradiance (in watts per square centimeters or Watts/cm²) as a function of distance along the y-axis (in millimeters or mm) showing the resulting irradiance profile generated by the system shown in FIG. 15A along the y-axis of the sample surface. FIG. 15C is a grey scale surface plot showing the illumination distribution generated by the system shown in FIG. 15A at the sample surface along the x-axis and the y-axis.

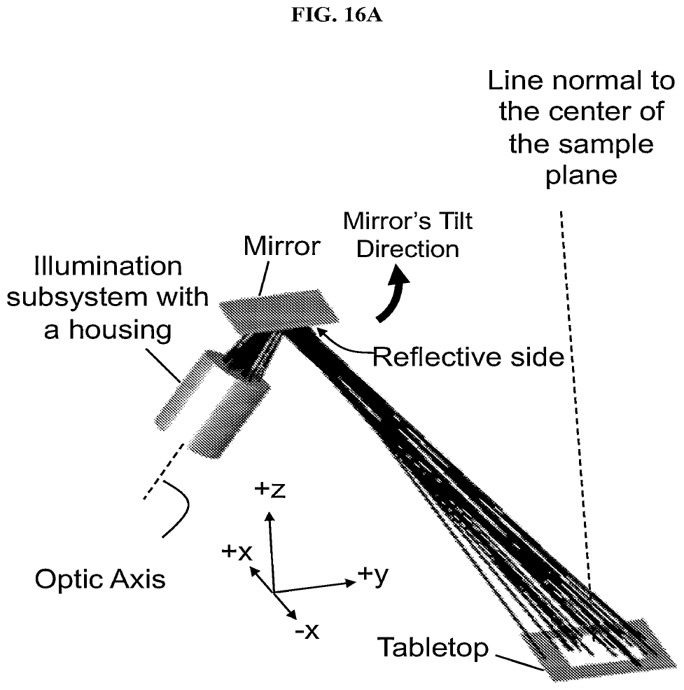

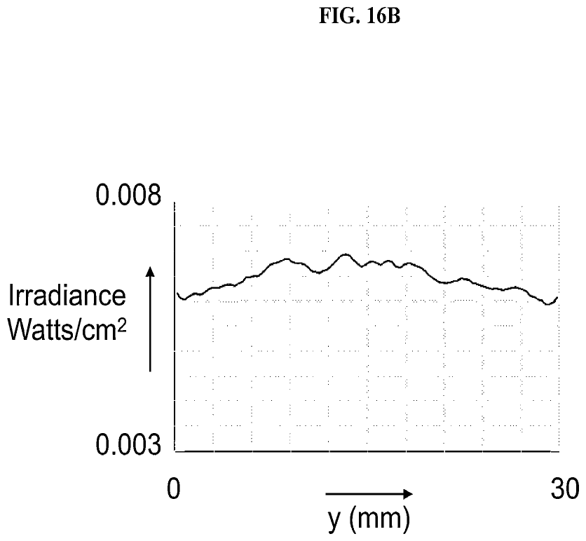

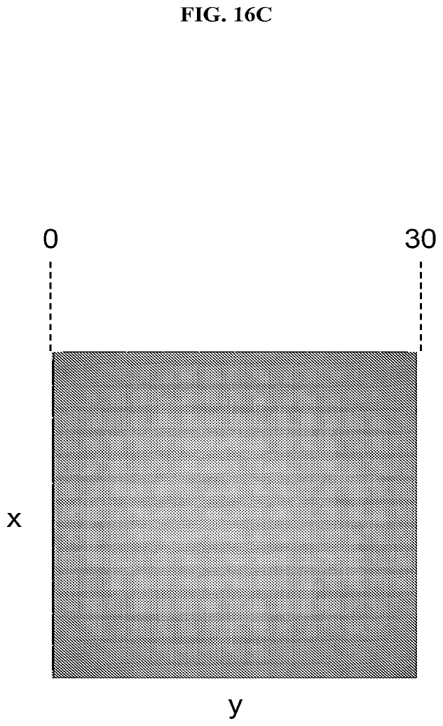

FIG. 16A is a schematic showing the illumination subsystem as illustrated in FIG. 12B according to various embodiments used in conjunction with a mirror according to various embodiments. FIG. 16B is a plot of irradiance (in watts per square centimeters or Watts/cm²) as a function of distance along the y-axis (in millimeters or mm) showing the resulting irradiance profile generated by the system shown in FIG. 16A along the y-axis of the sample surface. FIG. 16C is a grey scale surface plot of showing the illumination distribution generated by the system shown in FIG. 16A at the sample surface along the x-axis and the y-axis.

The mirror's width is 30 mm in the x-dimension, and 40 mm in the y-dimension. The thickness of the mirror is 2 mm. In order to set up the illumination subsystem shown in FIG. 16A, the illumination subsystem from FIG. 13A is rotated about a point 30 mm from the position of the front vertex of Lens C along the optic axis. The angle between the optic axis and the line normal to the center of the sample plane is 35 degrees. The reflective surface of the mirror faces down, and the center of the reflective surface is located 220 mm from the center of the sample plane. The mirror may not initially be able to deflect rays to produce symmetrical illumination, as the central ray (i.e., a ray colinear with the optic axis) reflects off the center of the reflective surface of the mirror and lands at the center of the sample surface. Equivalently, the angle between the optic axis and a line normal to the center of the mirror's reflective side is 35 degrees when the mirror is not deflecting rays to provide symmetric illumination. In order to produce the more symmetric illumination shown in FIGS. 16B-C, the mirror has been tilted by 0.65 degrees in the direction shown by the solid arrow, labelled with “Mirror's Tilt Direction”. Equivalently, in order to produce the more symmetric illumination shown in FIGS. 16B-C, the angle of incidence between the optic axis and a line normal to the center of the reflective side of the mirror is 35+0.65=35.65 degrees.

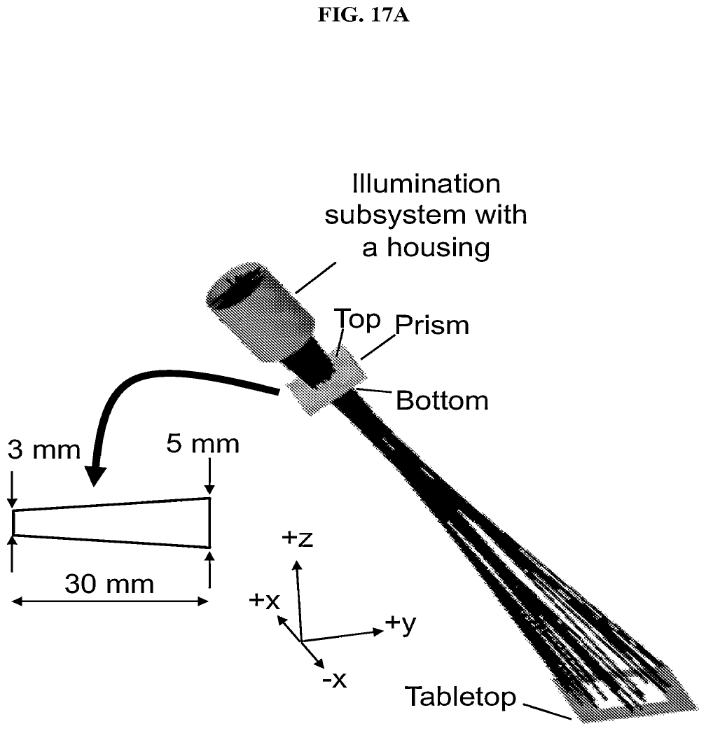

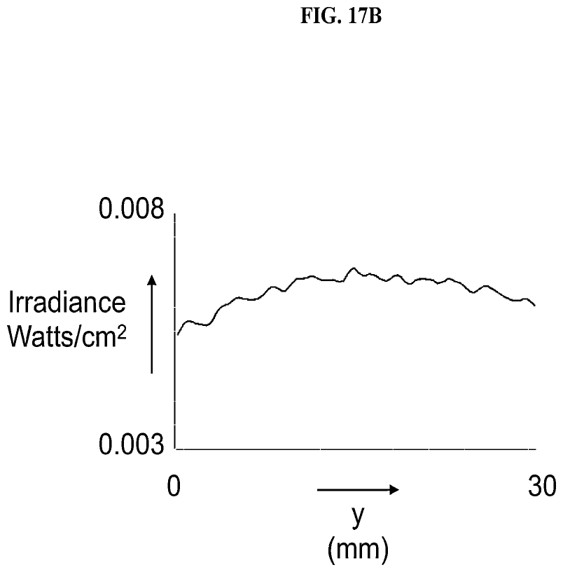

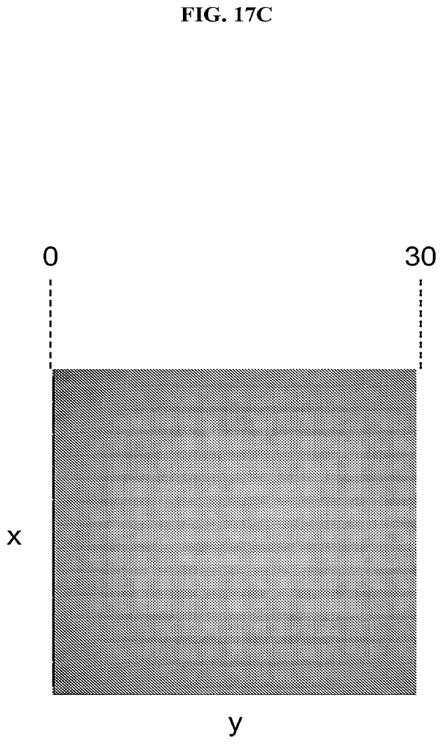

FIG. 17A is a schematic showing the illumination subsystem as illustrated in FIG. 12B according to various embodiments used in conjunction with a prism according to various embodiments. A prism with 5 mm dimension on the thick side is used instead of the prism shown in FIG. 14A. The results in a larger wedge angle, which deflects the rays farther in the +y direction at the sample plane, resulting in an asymmetric illumination distribution. FIG. 17B is a plot of irradiance (in watts per square centimeters or Watts/cm²) as a function of distance along the y-axis (in millimeters or mm) showing the resulting irradiance profile generated by the system shown in FIG. 17A along the y-axis of the sample surface. FIG. 17C is a grey scale surface plot showing the illumination distribution generated by the system shown in FIG. 17A at the sample surface along the x-axis and the y-axis.

In order to provide more illumination at the left end of the distribution shown in the plot of FIG. 17B, the source shifting method illustrated in FIG. 9 may be applied.

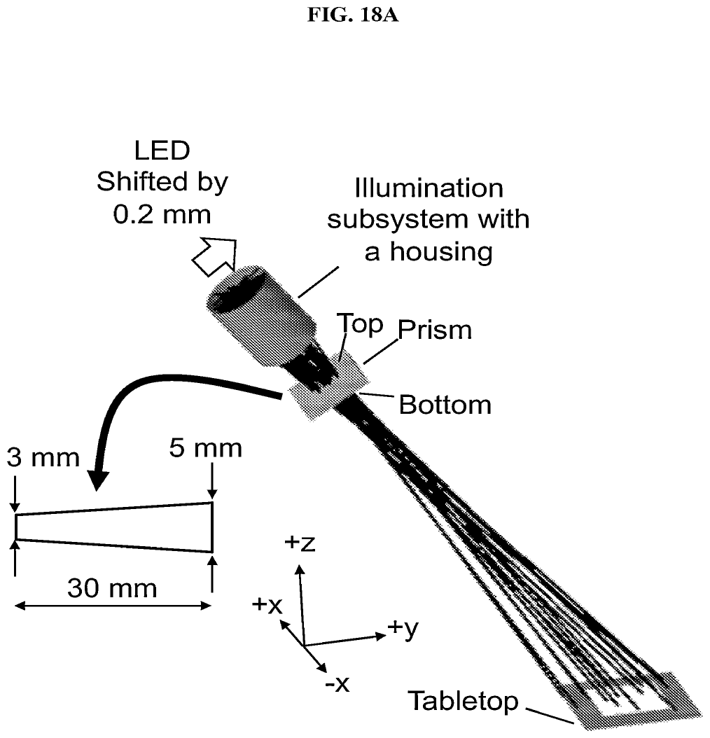

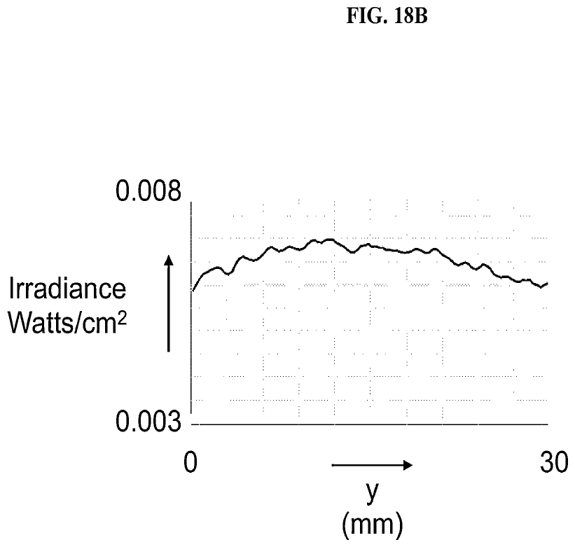

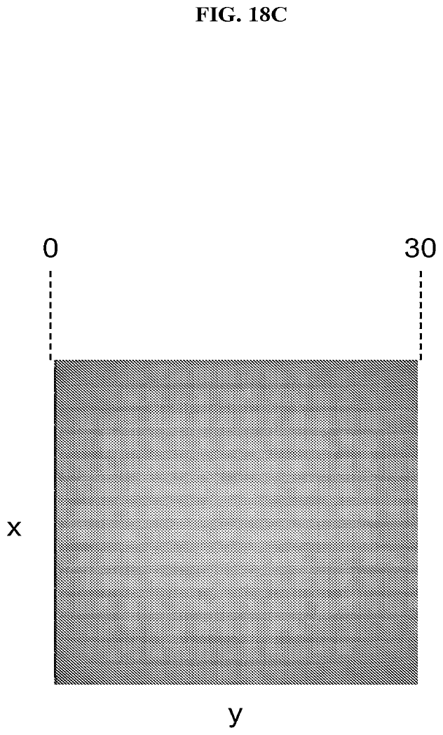

FIG. 18A is a schematic showing the illumination subsystem as illustrated in FIG. 12B according to various embodiments used in conjunction with the prism and with the optical source, i.e. the light emitting diode (LED), shifted by 0.2 mm in the direction shown by the arrow according to various embodiments. FIG. 18B is a plot of irradiance (in watts per square centimeters or Watts/cm²) as a function of distance along the y-axis (in millimeters or mm) showing the resulting irradiance profile generated by the system shown in FIG. 18A along the y-axis of the sample surface. FIG. 18C is a grey scale surface plot showing the illumination distribution generated by the system shown in FIG. 18A at the sample surface along the x-axis and the y-axis.

As shown in FIGS. 18B-C, shifting the optical source may result is an illumination distribution that is more symmetric.

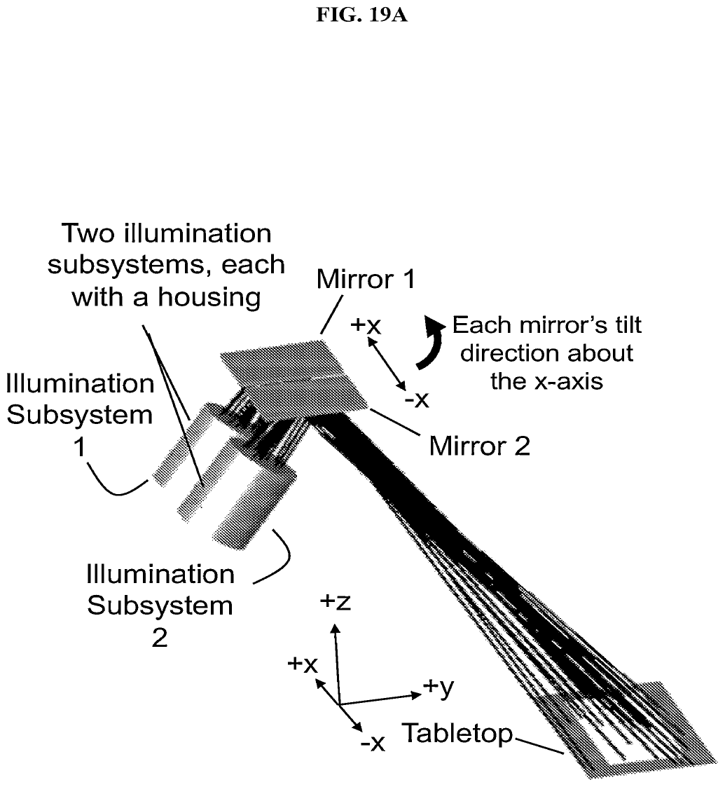

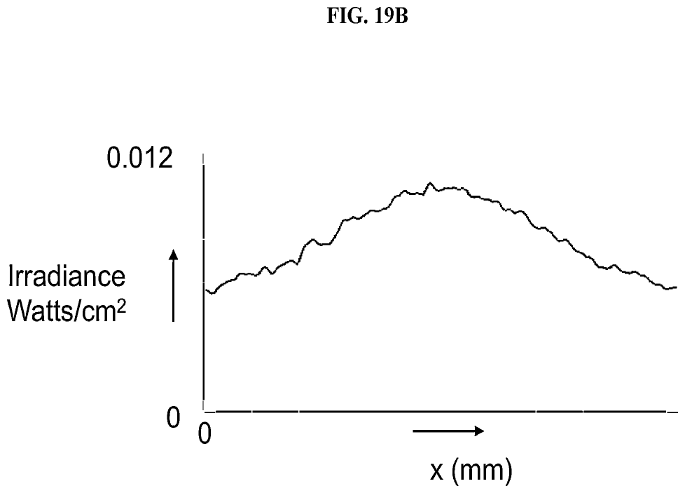

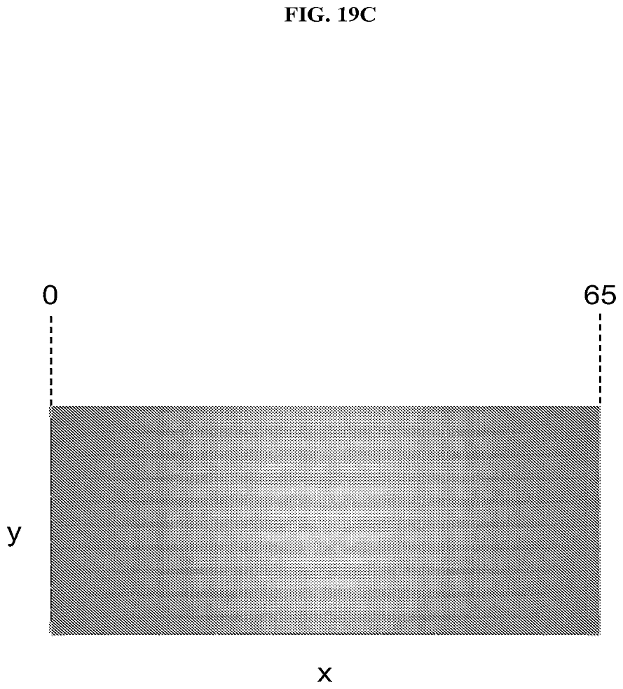

FIG. 19A is a schematic showing two illumination subsystems as illustrated in FIG. 12B according to various embodiments mounted next to each other according to various embodiments. FIG. 19B is a plot of irradiance (in watts per square centimeters or Watts/cm²) as a function of distance along the x-axis (in millimeters or mm) showing the resulting irradiance profile generated by the system shown in FIG. 19A along the x-axis of the sample surface. FIG. 19C is a grey scale surface plot showing the illumination distribution generated by the system shown in FIG. 19A at the sample surface along the x-axis and the y-axis.

In cases where the sample surface has an extended size (in this case, an extended x-dimension such that the sample surface measures 65 mm in the x-dimension and 30 mm in the y-dimension), more than a single illumination subsystem may be mounted besides one another. In FIG. 19A, a mirror may be used in conjunction with each illumination subsystem, with the same geometry for each illumination subsystem. For each of the two illumination subsystems, the oblique angle θ is 35 degrees, and the tilt of each mirror is 0.65 degrees in the direction shown by the arrow. The resulting illumination distribution has a significantly high irradiance at the center. This is due to overlapping light from the two distributions at the center of the sample surface. The resultant illumination is not a rotationally symmetric relative illumination, for it only appears to show symmetry across the x-dimension.

It may be possible to generate illumination distributions with greater symmetry (and therefore uniformity) if the pair of illumination subsystems are physically separated farther apart. In various embodiments, the separation between two neighboring illumination subsystems may be variable.

In various other embodiments, the separation between two neighboring illumination subsystems may be fixed. Still, it is possible to produce greater rotationally symmetric relative illumination by applying additional tilts to the two mirrors.

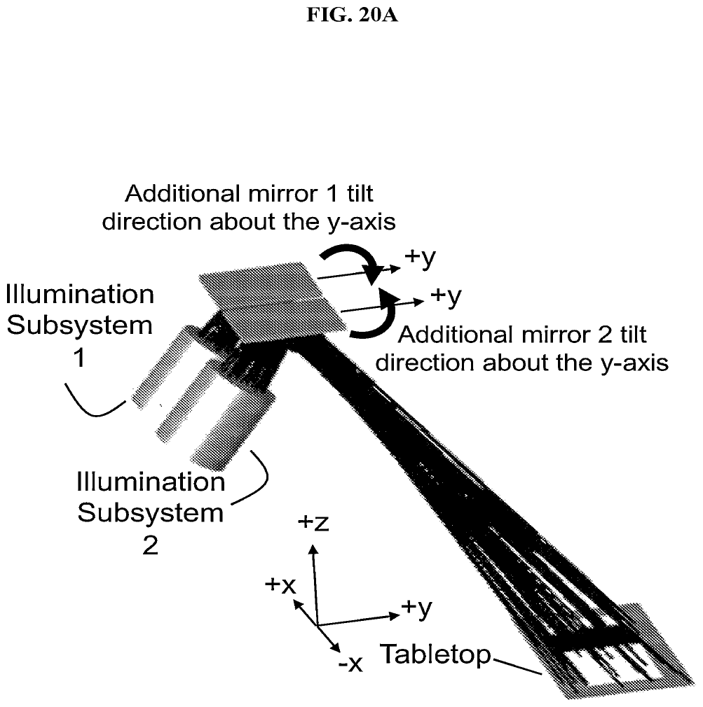

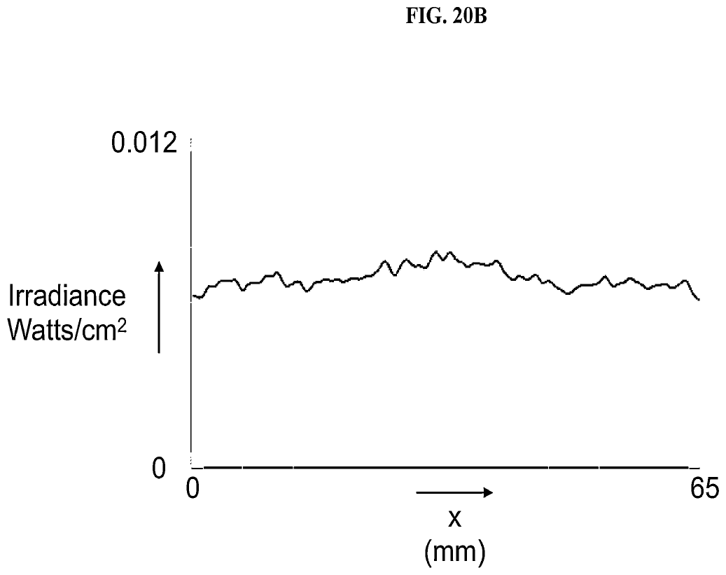

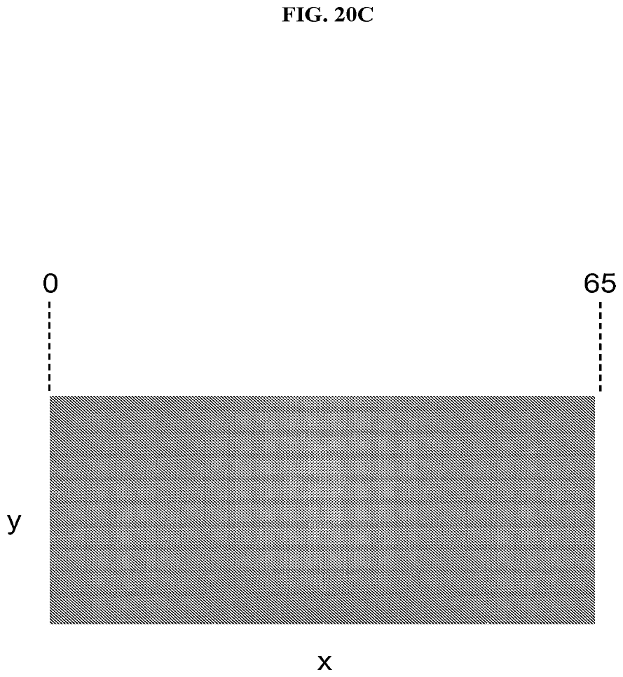

FIG. 20A is a schematic showing two illumination subsystems mounted next to each other as shown in FIG. 19A but with the mirrors tilted by 1 degree about the y-axis in the directions as shown according to various embodiments. Mirror 1 is tilted 1 degree about the y-axis in the clockwise direction, while mirror 2 is tilted 1 degree about the y-axis in the anticlockwise direction. Tilting the mirrors may deflect the beam in the +x direction for illumination subsystem 1, and in the −x direction for illumination subsystem 2.

FIG. 20B is a plot of irradiance (in watts per square centimeters or Watts/cm²) as a function of distance along the x-axis (in millimeters or mm) showing the resulting irradiance profile generated by the system shown in FIG. 20A along the x-axis of the sample surface. FIG. 20C is a grey scale surface plot showing the illumination distribution generated by the system shown in FIG. 20A at the sample surface along the x-axis and the y-axis. FIGS. 20B-C show improved x-dimension illumination uniformity. In the case as shown in FIG. 20A each mirror has been given tilts about the x and y axes, giving rise to improved illumination symmetry in the x and y dimensions. The resultant illumination distribution is also more uniform.

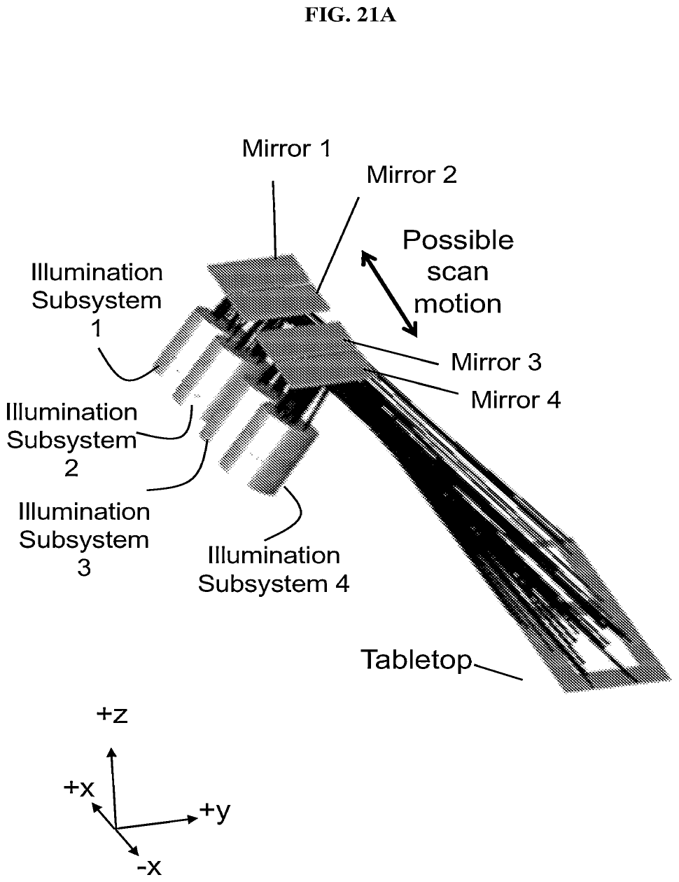

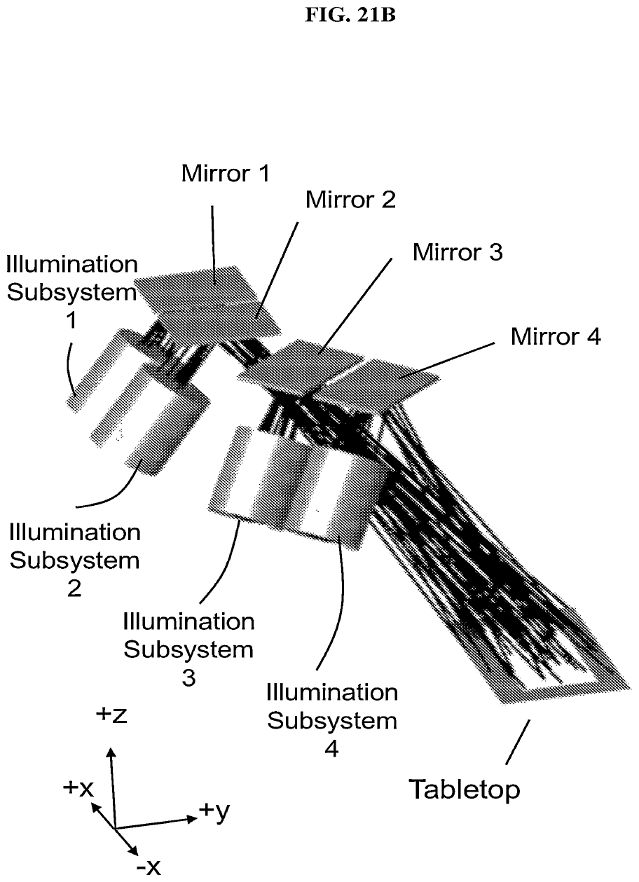

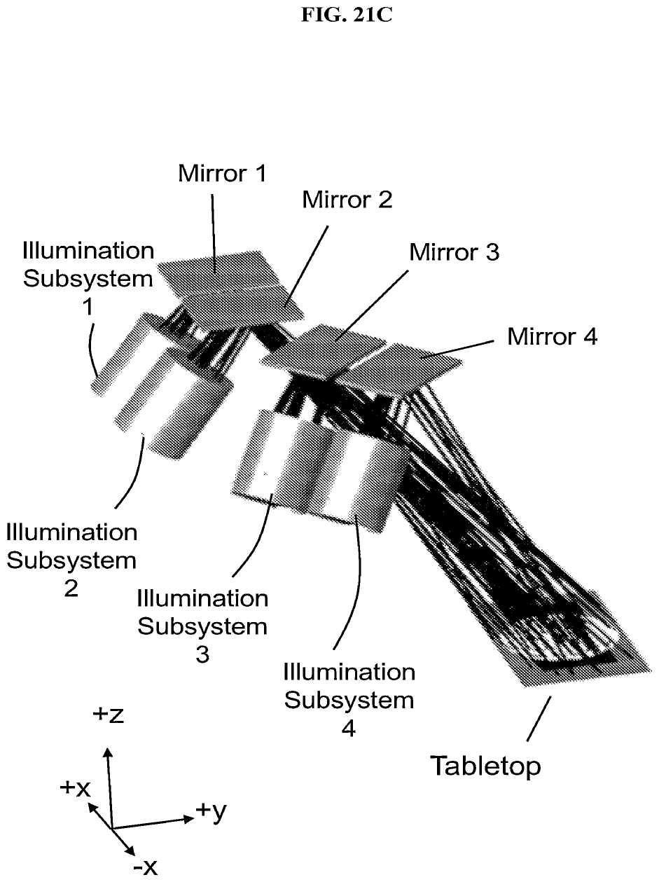

FIG. 21A is a schematic showing an optical system according to various embodiments. If the sample surface has a large size (e.g. in the x-dimension), an additional pair of illumination subsystems may be mounted. Each pair of illumination subsystems may scan in the directions indicated by the double arrows. This may be useful if filters are mounted in front of the illumination subsystems, and if subareas across the sample surface require different wavelengths of illumination.

FIG. 21B is a schematic showing an optical system according to various other embodiments. In various embodiments, pairs of illumination subsystems may be mounted on a rotating turret. FIG. 21C is a schematic showing an optical system according to yet various other embodiments. In various embodiments, the pairs of illumination subsystems may illuminate a circular sample surface.

In various embodiments, additional pairs of illumination subsystems may be mounted. In various embodiments, instead of mirrors, prisms or deflection lenses may be used.

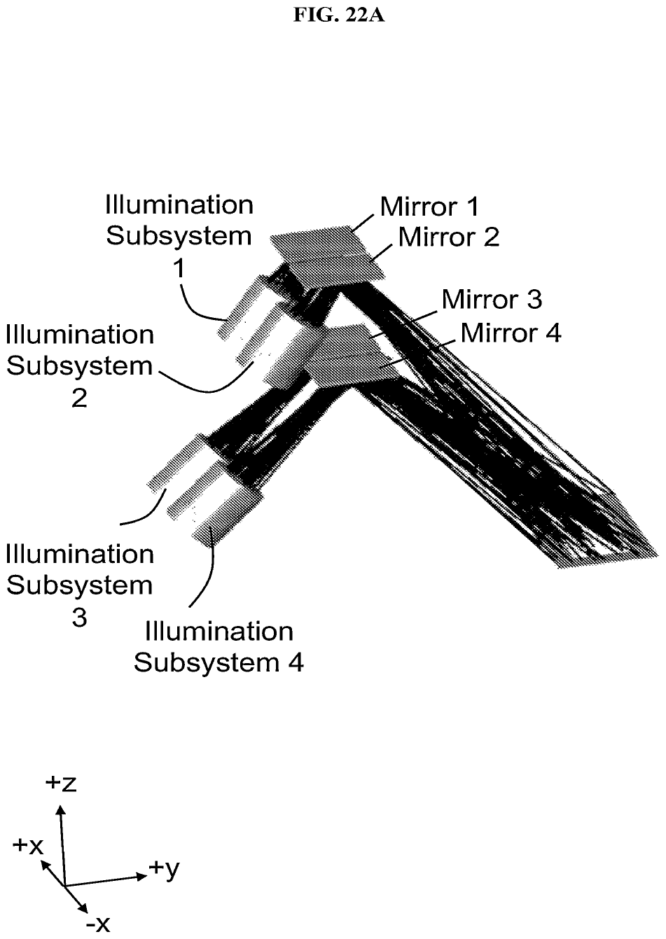

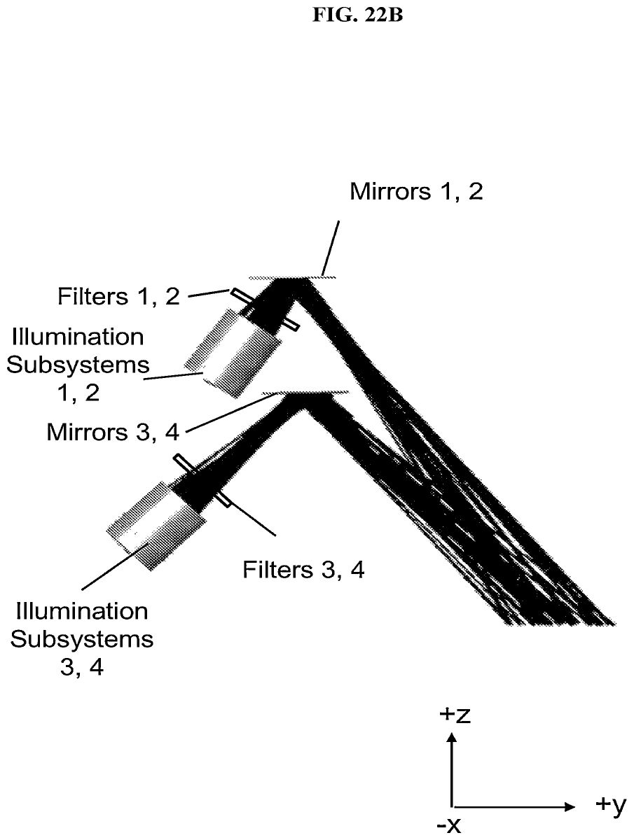

FIG. 22A is a schematic showing an optical system including two pairs of illumination subsystems according to various embodiments. FIG. 22B is a schematic showing a side view of the optical system shown in FIG. 22A with filters according to various embodiments. The filters are not shown in FIG. 22A to avoid clutter and improve clarity. The optical system as shown in FIGS. 22A-B may be similar to the system shown in FIGS. 10A-C. In various other embodiments, some of the mirrors may be replaced by deflection lenses or prisms, similar to that shown in FIGS. 11A-C.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of illuminating a sample surface, the method comprising:
arranging an illumination subsystem, the illumination subsystem comprising an optical source and at least one lens, having an optic axis at an incident angle greater than 0° and less than 90° to a normal of the sample surface such that a reference illumination distribution is directly generated on the sample surface based on optical light emitted by the illumination subsystem; and
arranging an adjustment optical subsystem consisting of an optical element selected from a prism, a deflection lens, and a mirror such that an adjusted illumination distribution having an irradiance profile more symmetrical compared to an irradiance profile of the reference illumination distribution is generated on the sample surface based on optical light emitted by the illumination subsystem.

2. The method according to claim 1, wherein the prism is arranged between the illumination subsystem and the sample surface such that optical light from the illumination subsystem is deflected by the prism to generate the adjusted illumination.

3. The method according to claim 1, wherein the deflection lens is arranged between the illumination subsystem and the sample surface such that optical light from the illumination subsystem is deflected by the deflection lens to generate the adjusted illumination.

4. The method according to claim 1, wherein the mirror is provided such that optical light generated by the illumination subsystem, which has been moved such that optical light travels away from the sample surface, is reflected by the mirror to generate a further reference illumination distribution on the sample surface;
wherein the mirror is tilted such that the adjusted illumination distribution is more symmetrical compared to the reference illumination distribution and more symmetrical compared to the further reference illumination distribution.

5. The method according to claim 1, wherein the mirror is provided such that optical light generated by the illumination subsystem, which has been moved so that the optic axis is parallel to the sample surface, and traveling along the optic axis is reflected by the mirror to generate a further reference illumination distribution on the sample surface;
wherein the mirror is tilted such that the adjusted illumination distribution is more symmetrical compared to the reference illumination distribution and more symmetrical compared to the further reference illumination distribution.

6. The method according to claim 1, further comprising:
moving the optical source such that an area of a central spot of illumination within the adjusted illumination distribution is increased.

7. The method according to claim 1, further comprising:
arranging a further illumination subsystem, the further illumination subsystem comprising a further optical source and at least one further lens, having a further optic axis at a further incident angle greater than 0° and less than 90° to a normal of the sample surface such that a further reference illumination distribution is directly generated on the sample surface based on optical light emitted by the further illumination subsystem; and
arranging a further adjustment optical subsystem such that a further adjusted illumination distribution which is more symmetrical compared to the further reference illumination distribution is generated on the sample surface based on optical light emitted by the further illumination subsystem.

8. The method according to claim 7, wherein the further adjustment optical subsystem comprises a further optical element selected from a group comprising a prism, a deflection lens, and a mirror.

9. The method according to claim 7, wherein the adjusted illumination distribution and the further adjusted illumination distribution are generated sequentially on the sample surface.

10. The method according to claim 7, wherein the adjusted illumination distribution and the further adjusted illumination distribution are generated concurrently so that the adjusted illumination distribution and the further adjusted illumination distribution overlap to form a resulting illumination distribution on the sample surface.

11. An optical system for illuminating a sample surface, the optical system comprising:
an illumination subsystem comprising an optical source and at least one lens; and
an adjustment optical subsystem;
wherein the adjustment optical subsystem, the adjustment optical subsystem consisting of an optical element selected from a prism, a deflection lens, and a mirror, is configured to be arranged such that an adjusted illumination distribution generated on the sample surface based on optical light emitted by the illumination subsystem has an irradiance profile more symmetrical compared to an irradiance profile of a reference illumination distribution generated directly on the sample surface based on optical light emitted by the illumination subsystem when the illumination subsystem is arranged such that an optic axis of the illumination subsystem is at an incident angle greater than 0° and less than 90° to a normal of the sample surface.

12. The optical system according to claim 11,
wherein the prism is arranged between the illumination subsystem and the sample surface such that optical light from the illumination subsystem is deflected by the prism to generate the adjusted illumination.

13. The optical system according to claim 11,
wherein the deflection lens is arranged between the illumination subsystem and the sample surface such that optical light from the illumination subsystem is deflected by the deflection lens to generate the adjusted illumination.

14. The optical system according to claim 11,
wherein the mirror is configured such that optical light generated by the illumination subsystem, which is configured to be moved such that optical light from the illumination subsystem travels away from the sample surface, is reflected by the mirror to generate a further reference illumination distribution on the sample surface; and
wherein the mirror is configured to be tilted such that the adjusted illumination distribution is more symmetrical compared to the reference illumination distribution and more symmetrical compared to the further reference illumination distribution.

15. The optical system according to claim 11,
wherein the mirror is configured such that optical light generated by the illumination subsystem, which is configured to be moved such that the optic axis is parallel to the sample, and traveling along the optic axis is reflected by the mirror to generate a further reference illumination distribution on the sample surface; and
wherein the mirror is configured to be tilted such that the adjusted illumination distribution is more symmetrical compared to the reference illumination distribution and more symmetrical compared to the further reference illumination distribution.

16. The optical system according to claim 11,
wherein the optical source is configured to be moved such that an area of a central spot of illumination within the adjusted illumination distribution is increased.

17. The optical system according to claim 11, further comprising:
a further illumination subsystem comprising an optical source and at least one lens; and
a further adjustment optical subsystem;
wherein the further adjustment optical subsystem is configured to be arranged such that a further adjusted illumination distribution generated on the sample surface based on optical light emitted by the further illumination subsystem is more symmetrical compared to a further reference illumination distribution generated directly on the sample surface based on optical light emitted by the further illumination subsystem when the further illumination subsystem is arranged such that an optic axis of the further illumination subsystem is at an incident angle greater than 0° and less than 90° to a normal of the sample surface.

18. The optical system according to claim 17, wherein the further adjustment optical subsystem comprises a further optical element selected from a group comprising a prism, a deflection lens, and a mirror.

19. The optical system according to claim 17, wherein the adjusted illumination distribution and the further adjusted illumination distribution are generated sequentially on the sample surface.

20. The optical system according to claim 17, wherein the adjusted illumination distribution and the further adjusted illumination distribution are generated concurrently so that the adjusted illumination distribution and the further adjusted illumination distribution overlap to form a resulting illumination distribution on the sample surface.
